(19) United States
(12) Patent Application Publication
(10) Pub. No.: US 2017/0262885 A1
(43) Pub. Date: Sep. 14, 2017

(54) FACILITATING COMMUNICATION WITH A VISITOR TO A WEB-BASED INFORMATION RESOURCE

(71) Applicant: SR Solutions, Inc., Maspeth, NY (US)

(72) Inventors: Jose Rodrigo Fuentes, Maspeth, NY (US); Sandeep Arneja, Jersey City, NJ (US)

(21) Appl. No.: 15/505,722

(22) PCT Filed: Aug. 24, 2015
(86) PCT No.: PCT/US15/46460

§ 371 Date: Feb. 22, 2017

Related U.S. Application Data
(60) Provisional application No. 62/041,610, filed on Aug. 25, 2014.

(51) Int. Cl. G06Q 30/02; H04L 12/24; H04L 29/08

(52) U.S. Cl. CPC G06Q 30/0255; H04L 67/22; H04L 67/02; H04L 67/146; H04L 41/046; G06Q 30/0277; G06Q 30/0269

(57) ABSTRACT

A computer-based method and system are disclosed to facilitate communicating with a visitor to a web-based information resource (e.g., a website or the like), particularly with advertising units directed toward that person after the person's visit to the web-based information resource is over. The method includes: tracking the person's activities on the web-based information resource, receiving instructions from an agent associated with the web-based information resource to communicate with the person whose activities have been tracked, creating the advertising unit with a communication to the person based on the agent's instructions, and causing the advertising unit to be displayed at the same or another web-based information resources, if it support advertising, for example, when that person visits that same or other web-based information resource.

### CROSS-REFERENCE TO RELATED APPLICATION(S)

This application claims priority to U.S. Provisional Patent Application No. 62/041,610, which was filed on Aug. 25, 2014 and was entitled, Facilitating Communication with a Visitor to a Web-Based Information Resource. The disclosure of the prior application is hereby incorporated by reference in its entirety herein.

### BACKGROUND

Businesses create web-based information resources, such as websites, at least in part, to attract new business opportunities (e.g., new customers or clients). However, website visitors certainly don't always turn into customers or clients. Moreover, these visitors, at least some of whom really represent potential new customers or clients, remain largely anonymous to the businesses who own the visited websites. So, unless a website visitor provides personal contact information to the business in question for follow-up communications, if the visitors do not become customers or clients during their visit to the website, they may leave and never come back, essentially being lost as a potential customer or client forever.

It can be frustrating to business owners and others invested in the success of a business when a potential new customer or potential new client visits the business' website and leaves without becoming a customer or client and without providing any personal contact information for a potential follow-up communication from the business.

### SUMMARY OF THE INVENTION

In a typical implementation, the technologies disclosed herein provide solutions to the problems mentioned above.

More particularly, in a typical implementation, these technologies help convert anonymous visitors to a website into sales-ready leads for a business. In one example, the technologies do this by enabling the business owner, for example, to send personalized follow-up communication(s) to the website visitor as he or she peruses other websites (e.g., ones that support display advertisements) after leaving the website of the business in question.

In one aspect, the specification describes a method and system for personalized communications anywhere (“PCA”). In summary, a person using an application to visit a web-based information resource (“WBIR”), such as website, may get tracked using digital advertising system (“DAS”) cookies and PCA cookies. Some or all of the person's activities at the WBIR are recorded and presented to an agent associated to the website. A web server receives input from the agent, such as a message directed to the person. In a typical implementation, the systems, techniques, etc. described herein converts the agent's input into ad units, which are displayed to the person using a digital advertising system.

In another aspect, a computer-based method facilitates communicating with a visitor to a web-based information resource (e.g., a website). The method includes tracking a person's activities on the web-based information resource, receiving instructions from an agent associated with the web-based information resource to communicate with the person whose activities have been tracked, creating an advertising unit with a communication to the person based on the agent's instructions, and causing the advertising unit to be displayed at one or more web-based information resources that support advertising.

Typically, the advertising unit is displayed at the one or more web-based information resources that support advertising in response to an indication that the person is visiting that one of the web-based information resources that supports advertising.

In some implementations, one or more of the following advantages are present.

For example, anonymous people who have visited and left a website can be converted into sales contacts and, sometimes, at least actual customers or clients of the business whose website was visited. Additionally, communicating can be made easier and more effective between business personnel on the one hand and potential customers or clients of the business on the other hand. Moreover, the functionalities disclosed herein are easy to set up and easy to use.

Other features and advantages will be apparent from the description and drawings, and from the claims.

### BRIEF DESCRIPTION OF THE DRAWINGS

FIG. 1 is a schematic representation of an exemplary network that facilitates communications with a visitor to a web-based information resource.

FIG. 2 is a schematic representation of data tables stored in a storage device.

FIG. 3A is a schematic representation of exemplary network components that help facilitate communications with a visitor to a web-based information resource.

FIG. 3B is a schematic representation of exemplary network components that help facilitate communications with a visitor to a web-based information resource.

FIG. 3C is a schematic representation of exemplary network components that help facilitate communications with a visitor to a web-based information resource.

FIG. 3D is a schematic representation of exemplary ad units.

FIG. 4A through 4G are schematic representations of exemplary network components and sets of network components that help facilitate communications with a visitor to a web-based information resource.

FIGS. 5 through 8B are flowcharts showing exemplary processes relating to helping to facilitate communications with a visitor to a web-based information resource.

FIG. 9 is an exemplary screenshot of a page from a website that supports display advertisements.

FIGS. 10, 11 and 11B are flowcharts of processes relating to helping to facilitate communications with a visitor to a web-based information resource.

FIG. 12 is an online profile of a website visitor.

FIG. 13 is a screenshot showing what a website visitor might see when they visit the website.

FIG. 14 is a screenshot showing what a website visitor might see when they visit the website.

FIG. 15 is a screenshot showing an exemplary report that an agent of business might receive through his email application.

FIG. 16 is a screenshot showing an exemplary reply message.

FIG. 17 is a screenshot that includes an exemplary ad unit directed to a website visitor.

FIG. 18 is a screenshot of an exemplary demo request page.

FIG. 19 is a screenshot showing an exemplary follow-up communication.

FIG. 20 is a screenshot showing an exemplary second advertising unit on a website.

FIGS. 21 and 22 are screenshots showing pages from an exemplary life insurance website.

FIG. 23 is an exemplary screenshot showing a news website.

FIG. 24 is a schematic representation of an exemplary implementation of a system to facilitate/implement one or more of the techniques disclosed herein.

### DETAILED DESCRIPTION

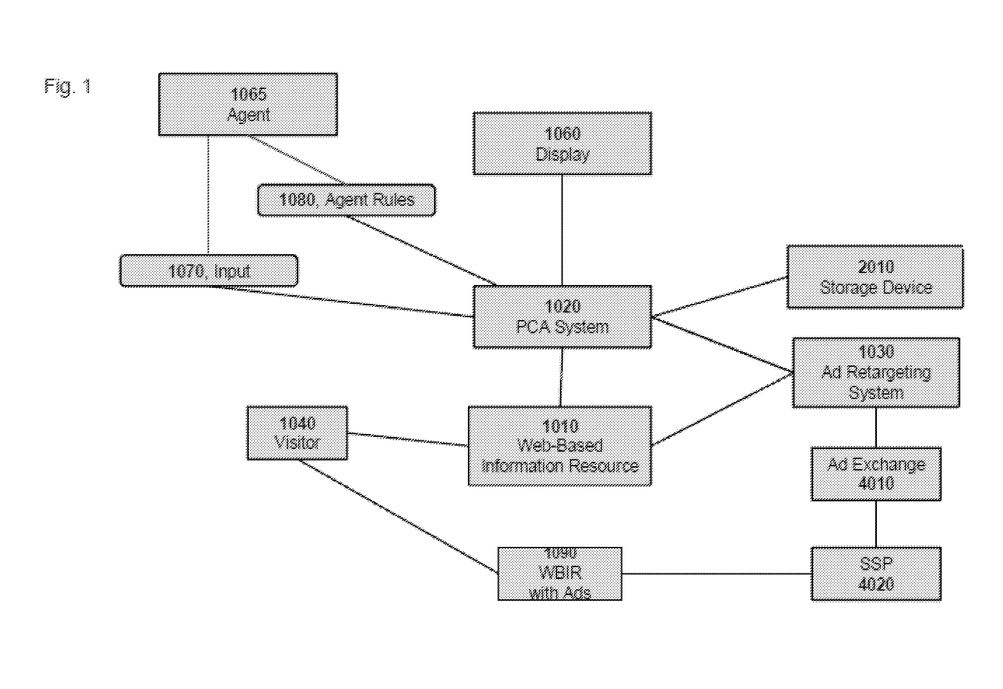

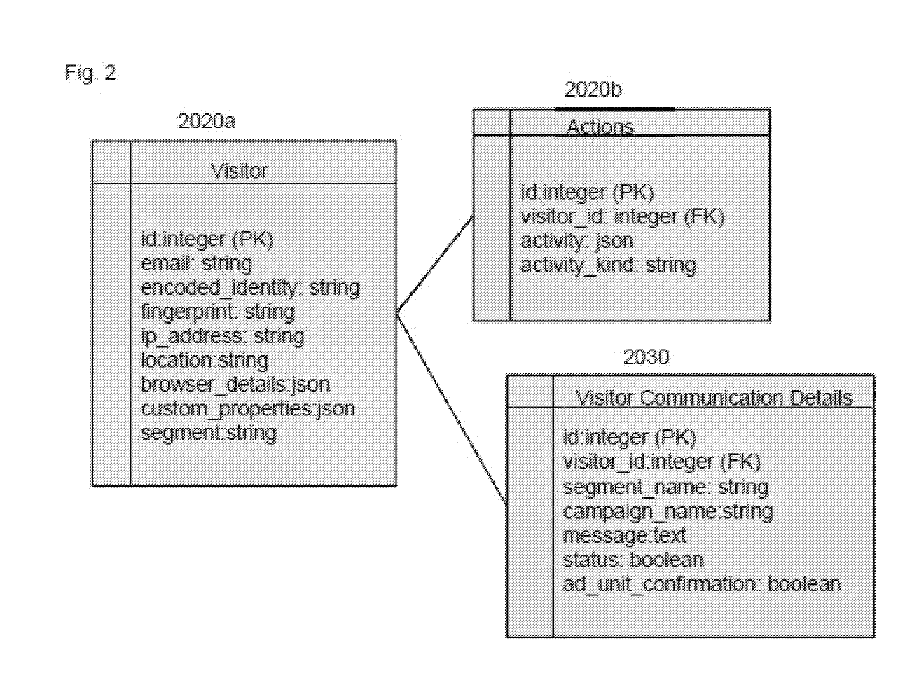

FIG. 1 is a schematic representation of a network that includes technologies that can help convert an anonymous visitor (e.g., 1040) to a website, at least potentially, into a sales-ready lead for a business.

In one example, the technologies do this by enabling a business owner or agent of the business owner, for example, to send personalized follow-up communication(s) to the website visitor as he or she peruses other websites (that support display ad functionality) after leaving the website of the business in question. These personalized follow-up communications can be based specifically on the visitor's activities at the website and/or other demographic information about the visitor. Moreover, they can be presented to the visitor in a display advertisement that appears on the visitor's computer device (e.g., laptop, desktop, smartphone, etc.) when the visitor subsequently visits one or more websites, such as news or social media sites, that are able to support display advertisements.

So, as a specific example, let's say “John” (a potential customer of XYZ, Inc. and visitor 1040 to the XYZ website) visits the website (1010) for XYZ, Inc. looking for information about integrating XYZ's customer relationship management (CRM) system into XYZ's software solution, but cannot find what he is looking for. Let's also assume that John 1040 is willing to speak with a sales representative for XYZ, Inc. to ask about the specific information he needs. So, after searching the XYZ, Inc. website for a while, John clicks on a “Contact Us” button to try to reach a sales representative. This brings up a lead capture form on the website asking John 1040 to provide all sorts of personal contact information (e.g., his name, his company, his address, his email address, his phone number, etc.). Let's also assume that John 1040 decides not to fill out the form, which is a common decision among website visitors—maybe John 1040 is too intimidated, maybe John 1040 is too busy, maybe John 1040 just knows that if he fills out the lead capture he is going to be hounded by sales teams. So, instead of filling out the form, John 1040 decides to look research other vendors (at other websites) for the information he needs and leaves the XYZ, Inc. website without becoming a customer of XYZ, Inc. and without even providing any personal contact information that XYZ, Inc. might be able to use to follow-up with John.

Without the technologies disclosed herein (and incorporated into the network of FIG. 1), John, in the foregoing example, would represent a lost opportunity to XYZ, Inc. This type of scenario plays out all too frequently for businesses that have a web-presence.

In a typical implementation, the technologies disclosed herein (and incorporated into the network of FIG. 1) enable XYZ, Inc. (via agent 1065) to follow-up with John 1040 (after leaving the XYZ website) in a personalized, meaningful way, even though John 1040 left no personal contact information at the XYZ, Inc. website for XYZ, Inc. to do that. More particularly, in a typical implementation, the technologies disclosed herein provide a report (via email or on a web-interface, etc.) to someone at XYZ, Inc. (e.g., agent 1065) that includes information about the anonymous visitor's (here, John) activities on the XYZ website and/or other demographic information about John 1040. This information typically won't include John's name, or specific contact information, but it can include, for example, an identification of what portions of the XYZ website the visitor (John 1040) viewed (e.g., that the visitor clicked the “CRM integration” tab numerous times, etc.) and provides demographic information about the visitor (John 1040), such as the name of John's company (e.g., Madeupname, Inc.), which can sometimes be derived by a using a reserve IP address lookup function.

Moreover, in a typical implementation, the technologies disclosed herein (and incorporated into the network of FIG. 1) enable a person at XYZ, Inc. (e.g., agent 1065) to craft a personalized message to John such as follows that the network will deliver to John 1040 when John 1040 subsequently visits, for example, some other website 1090 (e.g., a news or social media website) that supports display advertisements, after leaving web-based information resource 1010. An example of this kind of personalized message follows:
Hi Madeupname, Inc.,
I understand that you may be interested in CRM integration. I'd be happy to try to answer any questions you may have about integrating our CRM products.
Please call me anytime at XXX/XXX-XXXX.
Regards,
Greg

Once the message is created and entered into the network, the network can deliver it (or present it) to John when John visits, for example, some other website or websites (e.g., a news or social media website) that support display advertisements. This establishes a direct, personalized needs-specific message to John that may help convert John, who by all means was a viable sales lead albeit anonymous, into a known lead and, perhaps, eventually, an actual customer of XYZ, Inc.

The technology is easy to install and easy to use. Typically, installation involves having someone (e.g., agent 1065) at the business (e.g., XYZ, Inc.) visit a website (e.g., listenloop.com) that supports and facilitates these functionalities and register for an account. Then, that person 1065 can simply complete a JavaScript integration (e.g., into the XYZ, Inc. website) to help support the functionalities. The website that supports the functionalities then provides access to a dashboard-type interface where the user 1065 can set up specifics about how the system will work with respect to the business in question (e.g., XYZ, Inc.). These specifics may include, for example, what advertisements should be shown, what drip messages should be included in the advertisements, logic that determines what advertisements should be displayed to a given visitor based on his or her behavior and/or demographic information, etc.

The network and associated functionalities then go live and start automatically serving up correct display advertisements for different visitors (e.g., visitor 1040) based on those visitors' individual behaviors (at 1010) and/or demographic information (e.g., as those visitors subsequently peruse other websites, e.g., 1090, that support display advertisements or the like).

At its heart, the illustrated network includes a personalized communications anywhere (“PCA”) system 1020. In a typical implementation, the PCA system 1020 is a computer-based server or servers connected as shown into the illustrated network. Many of the components illustrated in the network of FIG. 1 are implemented using computer-based servers and/or computer-based user interface terminals, such as laptops, desktops, smartphones or the like.

The network includes a storage device 2010 coupled to the PCA system 1020. Also coupled to the PCA system 1020 is an ad retargeting system 1030. In a typical implementation, the ad retargeting system 1030 is configured to serve ads to people more frequently after they have left a publisher's website. Generally speaking, a user will be shown a retargeting ad as frequently as possible unless, for example, a frequency cap has been placed by the advertiser.

There is an ad exchange 4010 coupled to the ad retargeting system 1030. Generally speaking, an ad exchange is a technology platform that facilitates the buying and selling of media advertising inventory whose prices are determined through bidding from multiple ad networks or other sources. There is a supply side platform (“SSP”) 4020 coupled to ad exchange. In general, a SSP 4020 is a technology platform with the mission of enabling publishers to manage their advertising impression inventory and try to maximize revenue from digital media. As such, they offer an efficient, automated and secure way to tap into the different sources of advertising income that are available, and provide insight into the various revenue streams and audiences.

There is a pair of web-based information resources 1010 and 1090 (e.g., websites) shown in the illustrated network. Web-based information resource 1010 is shown schematically coupled directly to the PCA system 1020. This web-based information resource 1010 may be a website for a business who wants to better engage its potential customers/clients. Web-based information resource 1090 may be, for example, a news or social media website and is not shown schematically as being directly coupled to the PCA system 1020.

The box labeled “1040 Visitor” represents a human visitor (or a human visitor's computer-based network interface) that can access (or visit) web-based information resources 1010 and/or 1090.

Similarly, the box labeled “1065 Agent” represents a human agent (or a human agent's computer-based network interface, or simply a computer executing functions based on instructions from an agent) of the business whose website is represented by web-based information resource 1010. As schematically represented in the illustrated network, the agent 1065 provides input 1070 and/or agent rules 1080 to the PCA system 1020.

Various aspects of particular functionalities of the network in FIG. 1 and/or similar networks and/or network components are discussed below.

Using Retargeting Systems

According to one exemplary implementation, a web-based information resource, such as a website, 1010 communicates with a PCA System 1020 and a Retargeting System 1030. For instance, the website may include a PCA JavaScript file (“PCA JS file”) and a re-targeting JavaScript file (“retargeting JS file”) for that purpose. In some implementations, the retargeting system is an existing retargeting system, such as the systems provided by GetIntent.

A website 1010 may communicate with a Retargeting System 1030, which may provide a JavaScript file that adds cookies to a browser 1040, among other things. Otherwise, the PCA System 1020 may provide its own re-targeting JavaScript file—either through a partner program or the System's own retargeting system. It is understood that other communications means are possible, such as by using an API in the client- or server-side.

In one embodiment, a browser 1040 visits the website 1010, and the PCA JS and retargeting JS files execute commands to identify the browser 1040. For instance, (1) the PCA JS file may execute commands to create a non-cookie device ID (or “fingerprint”) for that browser 1040, (2) the PCA JS file may execute commands to add a PCA cookie to the browser 1040, and (3) the retargeting JS file may execute commands to add a retargeting cookie.

It is understood that a browser 1040 refers broadly to a person or a machine on a device capable of rendering HTML, CSS, JS, and the like. The term “user” and “browser” are used interchangeably.

The browser 1040 interacts with website 1010, such as when a user 1040 visits pages, clicks on hyperlinks, answers onsite survey questions, fills out a form, or downloads an eBook (the “person's activities”).

The PCA JS file records the person's activities in a storage device 2010. The PCA JS file may associate the activities with that browser's 1040 device ID (e.g., fingerprint #XYZ) and may place a cookie on the browser 1040. Likewise, the retargeting JS file may add its own cookie to the browser 1040. The PCA JS file may communicate the fingerprint and/or cookie information to the PCA System 1020.

The storage device 2010 may be a database server, localStorage on a browser, or other means of recording information on a network.

The PCA System 1020 may communicate with the Retargeting System 1030, instructing the Retargeting System to associate the browser 1040 and the retargeting cookie thereon with a retargeting segment identified by the browser's 1040 fingerprint.

The foregoing step may be accomplished by various means. For instance, the PCA System 1020 may call the existing Retargeting System's 1030 API when available or navigate to a webpage (provided by the Retargeting System) and execute the necessary commands via a hidden iframe.

In this embodiment, where the PCA System 1020 is coordinating with a website's 1010 existing Retargeting System 1030, the PCA System 1020 may call an API function, such as “add_visitor_to_segment” provided by the Retargeting System 1030 to create and/or add a browser 1040 to a retargeting segment, such as “segment_XYZ”. Note that, in this embodiment, the naming convention of the retargeting segment includes the fingerprint string.

By calling the API function, the Retargeting System 1030 may read its own cookie on that browser 1040 and add that cookie to a retargeting segment, such that certain advertisements will be shown to only browsers in that retargeting segment.

At some point, the browser 1040 may exit the website 1010.

The PCA System 1020 may access information about that browser 1040 from a storage device 2010, including a tracking identifier for the retargeting segment. The PCA System 1020 may generate a report about the browser 1040 activities at the website 1010, such as time on website, number of clicks, pages visited, and so on.

The PCA System 1020 may present such a report at a display 1060. Said communication may occur by various means, such as an email, website, mobile app, or the like. In this embodiment, the PCA System 1020 communicates the report to a computer display 1060 via an email sent to an agent associated with the website 1065.

In another embodiment, the PCA System 1020 may present the report to a computer display 1060 via a web application that is renderable by a web browser. In other embodiments, the PCA System 1020 may present the report to a mobile display via a mobile application.

The PCA System 1020 may process client input 1070 from one or more input modalities. For instance, the PCA System 1020 may receive input 1070 via email, SMS, mobile application, web application, and/or other event input (e.g, an API function).

In this embodiment, an agent associated to the website 1065 wishes to engage a person at browser 1040 with a message.

In response to a report presented at display 1060, the agent 1065 prepares a message 1070 to engage the person at browser 1040, such as:
“Hi there! Looks like you were interested in requesting a demo at our website. I noticed that you visited our FAQ. Did you find the answers you were looking for? Let's schedule a quick call if that's helpful. -Diego”

In one embodiment, the report presented at display 1060 is communicated via email, and the agent 1065 may prepare the message above 1070 in her email application, wherein the reply-to address is associated to the PCA System 1020.

In another embodiment, the report presented at display 1060 is communicated via a web application, and the agent 1065 may prepare a response message 1070 through that web application.

In another embodiment, the report presented at display 1060 is communicated via a mobile application, and the agent 1065 may prepare a response message 1070 through that mobile application.

In this embodiment, the PCA System 1020 may receive the email communicated by the agent 1065 as input 1070. That email response 1070 may include information about the browser 1040 such that the PCA System 1020 can associate the message in the email response 1070 to the browser's 1040 fingerprint and cookies.

The input 1070 may include a URL, such as a landing page for the website 1010. If the agent 1065 does not include a URL in the input 1070, the PCA System 1020 will associate a default URL, such as the homepage of the website 1010, to the input 1070.

In some implementations, the PCA system 1020 is configured to support automated advertising function, whereby the agent 1065 creates nurture tracks that auto-respond based on visitor behavior and/or customer relationship management (CRM) status information. For example, an agent 1065 may pre-configure inputs in the PCA System 1020 based on visitor behavior or demographics. For instance, the agent 1065 may configure the PCA System 1020 to display an ad unit with message:
“Acme Co., thanks for requesting a demo. Consider downloading our white paper on how we've helped other anvil companies.”
   in response to a visitor submitting a demo request form after visiting the “/anvil.html” webpage and having CRM lead status, “Open.” As another example, another ad unit may convey:
“Acme Co., thanks for requesting a demo. Stay in touch with our newsletter and blogs.”
   in response to a visitor submitting a demo request form and having CRM lead status, “Unqualified.” In short, while an agent 1065 may provide manually input 1070 for each visitor that is not necessary by using pre-configured messages.

The PCA System 1020 processes the input 1070 and generates one or more corresponding ad units. In one embodiment, the PCA System 1020 processes the email response 1070 and converts that input into one or more ad unit images with dimensions 300×250 pixels (hereafter the “retargeting ad unit”).

When the input 1070 contains text, the PCA System 1020 may convert such text into an image by various means. For instance, the PCA System 1020 may process text from the input 1070 and create an image, and optionally transform the text to fit within a particular dimension. Alternatively, the input 1070 may be constrained by character limits to facilitate converting the input 1070 into an image.

There are other ways to create ad units from input 1070, such as by converting input into HTML, into images, and/or into animations. For example, some Retargeting Systems 1030 accept image-based ad units only, whereas others may accept HTML, JavaScript, Adobe Flash, and so on.

The PCA System 1020 may transmit the retargeting ad unit to a Retargeting System 1030, which may be placed in a storage device internal or external to the Retargeting System 1030. The PCA System 1020 may be configured to transmit such retargeting ad unit in real-time or not.

The PCA System 1020 may transmit a URL associated to the retargeting ad unit to the Retargeting System 1030, wherein the URL is the landing page associated to the input 1070 (the “Prospect Message URL”). The PCA System 1020 may append additional URL parameters to the Prospect Message URL, such as “?seg=segment_xyz&other_identifier=abc” (the “Additional URL Parameters”). Together, the Prospect Message URL and the Additional URL parameters may look something like this, “http://www.some-landing-page.com/?seg=segment_xyz&other_identifier=abc” (the “PCA Landing Page URL”).

This PCA System 1020 may transmit the aforementioned data to a Retargeting System 1030 in various ways. For instance, an agent for the website 1065 could provide its Retargeting System credentials (e.g., username/pw) to the PCA System 1020. Then, the PCA System 1020 could execute a series of steps from a browser, emulating a person, to perform the actions necessary to transmit an ad unit from the Retargeting System's 1030 web application GUI. Alternatively, the agent for the website 1010 could provide its API keys for the Retargeting System 1030, such that the PCA System 1020 could use an API to transmit the necessary data and/or instructions. In another embodiment, where the Retargeting System 1030 is part of a “partner network” or where the PCA System 1020 offers its own Retargeting System 1030, then the PCA System 1020 does not need additional information from the agent of the website 1010 to transmit information and create ads at the Retargeting System 1030.

The PCA System 1020 may transmit information to the Retargeting System 1030 to create an ad unit that contains one or more retargeting ad units and the PCA Landing Page URL (the “PCA Ad Unit”). Unless otherwise specified in the input 1070, the PCA System 1020 will also transmit default values to successfully create an ad unit at the Retargeting System 1030, such as a campaign name, budget, bid amount, schedule, location, and visitor segment.

The PCA System 1020 may choose a visitor segment at the Retargeting System 1030 for the PCA Ad Unit. For example, the PCA System 1020 may choose a segment titled, “segment_xyz”, corresponding to the retargeting segment the PCA System 1020 had associated with browser 1040.

In one embodiment, the retargeting segment, “segment_bucket_1” contains multiple browsers. The Retargeting System 1030 may be configured to display the PCA Ad Unit to that retargeting segment only, retrieving the ad unit (e.g., content) for display to a given browser by (i) reading a cookie, fingerprint, or device ID on the browser and (ii) querying a storage device for a matching cookie, fingerprint, or device ID.

In another embodiment, the PCA System 1020 may add a cookie to place a browser in retargeting segment, “segment_bucket_1” that is associated to a campaign with aggressive bid and budget settings to communicate an ad unit to said browser on a WBIR that supports advertising. The PCA System 1020 may add a new cookie associated with segment, “long_term_bucket” to the browser, where another campaign associated to the “long_term_bucket” segment is configured with low bidding and budget settings as a means to maintain a messaging conduit to a browser. Occasionally, the PCA System 1020 causes an ad unit to be displayed to the browser via the “long_term_bucket” segment, and the PCA System 1020 adds a new cookie, “segment_bucket 2” that has aggressive bidding and budget settings as a means to communicate an ad unit to the browser. In this way, a browser may be selectively moved to and from segments, preserving the ability to communicate to the browser at a cost that is lower than maintaining said browser in “segment_bucket_1”

In one embodiment, the retargeting segment, “segment_XYZ”, has one browser in the segment, browser 1040. The Retargeting System 1030 may be configured to display the PCA Ad Unit to that retargeting segment only. As a result, the PCA Ad Unit may be displayed only to the browser 1040.

In another embodiment, the PCA System 1020 may process Agent Rules 1080 to programmatically create one or more PCA Ad Units for more than one browser. For instance, the Agent Rules 1080 may indicate that all browsers that have not returned to the website 1010 in the last five days and had visited the “About Us” page more than twice should receive the following message as a PCA Ad Unit:
“Thanks for visiting my website. It's been 5 days since we've seen you on our site. I noticed that you visited the About Us page. Do you have any questions I can answer?—Joe”
   Browsers matching the aforementioned conditions would receive a PCA Ad Unit with the message immediately above.

In other embodiments, the website 1010 may have information about each person or browser, such as a “company name” stored in a cookie. The PCA System 1020 may programmatically incorporate such information into the PCA Ad Unit to personalize the message to each browser.

For instance, a browser 1041 visits Metlife.com and submits a form containing the following variables, “state_of_residence”, “date of birth”, “first name”, “years_of_coverage,” and “health” (the “Life Insurance Variables”). Based on that information, the MetLife website displays a quote for the requested term life insurance coverage. The PCA System 1020 may detect or receive the Life Insurance Variables and the quoted amount as input 1070. The PCA System 1020 may programmatically generate a PCA Ad Unit referencing the variables and quote amount noted above, like so:
“Thanks for requesting a quote for 20 years of term life insurance. We quoted you $50/mo based on your excellent health and NY residence.
Choosing life insurance can be intimidating. Let's schedule a call so we may answer any questions you might have.
-Joe, your MetLife representative”

Whereas another browser 1042 that visits Metlife.com and submits different Life Insurance Variables, they may receive this PCA Ad Unit:
“Hi Victor, thanks for requesting a quote for 30 years of term life insurance. We quoted you $65/mo based on your good health and TX residence.
Choosing life insurance can be intimidating. Let's schedule a call so we may answer any questions you might have.
-Joe, your MetLife representative”

When the browser 1040 is visiting another website 1090, such as CNN.com, the PCA Ad Unit may be displayed there via a Retargeting System 1030 (which, in some embodiments, may operate through an ad network that may include an ad exchange 4010 and/or a supply-side platform 4020). The effect is displaying a personalized message from the agent 1065 at the CNN.com website 1090 to the browser 1040.

If the browser 1040 clicks on the PCA Ad Unit, the ad will direct the browser to the PCA Landing Page URL. In one embodiment, the PCA Landing Page URL includes the PCA JS file, which may recognize any Additional URL Parameters in the URL string. The PCA System 1020 may be configured to detect that the browser 1040 came from a particular PCA Ad Unit at CNN.com. Optionally, the PCA System 1020 may remove the browser 1040 from retargeting segment, “segment_xyz”, such that the browser 1040 will not receive that PCA Ad Unit again. In effect, the PCA System 1020 may control whom, how, when to display a PCA Ad Unit via a Retargeting System 1030.

In another embodiment, the PCA System 1020 may use referrer tags, rather than URL parameters to detect that the browser 1040 came from a particular PCA Ad Unit at CNN.com. Here, the PCA Landing Page URL would direct the browser 1040 to an intermediary page, and the PCA System 1020 may remove the browser 1040 from retargeting segment, “segment_xyz”, such that the browser 1040 will not receive that PCA Ad Unit again.

Note, however, that it is not necessary for the PCA System 1020 to remove the browser 1040 from segment_xyz. The PCA System 1020 may keep that browser 1040 in segment_xyz to deliver a different PCA Ad Unit in the future.

In another embodiment, the PCA System 1020 may communicate to the Retargeting System 1030 to delete the retargeting segment, rather than removing the browser 1040.

In some implementations, browser actions are not limited to a person's behaviors on a website in that session. For instance, a person may be surveyed on a website with questions like “What's your first name?”, “What's your job title?”, “Where do you work?” across multiple sessions and/or across multiple websites. The PCA System 1020 may store such information in storage device 2010, in addition to that person's browser 1040 unique ID (e.g., fingerprint #XYZ) and PCA cookie. The PCA System 1020 may access information about that browser 1040 from storage device 2010 to generate a report that includes the responses to the questions above. Such information would be useful to an agent of the website 1065 to create personalized messages that are displayed as PCA Ad Units via a Retargeting System 1030.

Furthermore, a person's responses to the questions above would be associated to a fingerprint that may be persistent across web based information resources. For example, assume that a browser 1040 is on website www.abc.com, and they get a question in the website, “What's your first name?” and they answer, “Bill.” Then the same browser visits another website www.xyz.com. Now the agent 1065 at xyz.com may see that the first name of the visitor 1040 is “Bill”, giving the agent an enhanced ability to personalize a message 1070—without having to ask the question “What's your first name” again. This example can be repeated with any number of question/response pairs, such as “Where do you work?” and “What is your job title?

### Another Embodiment

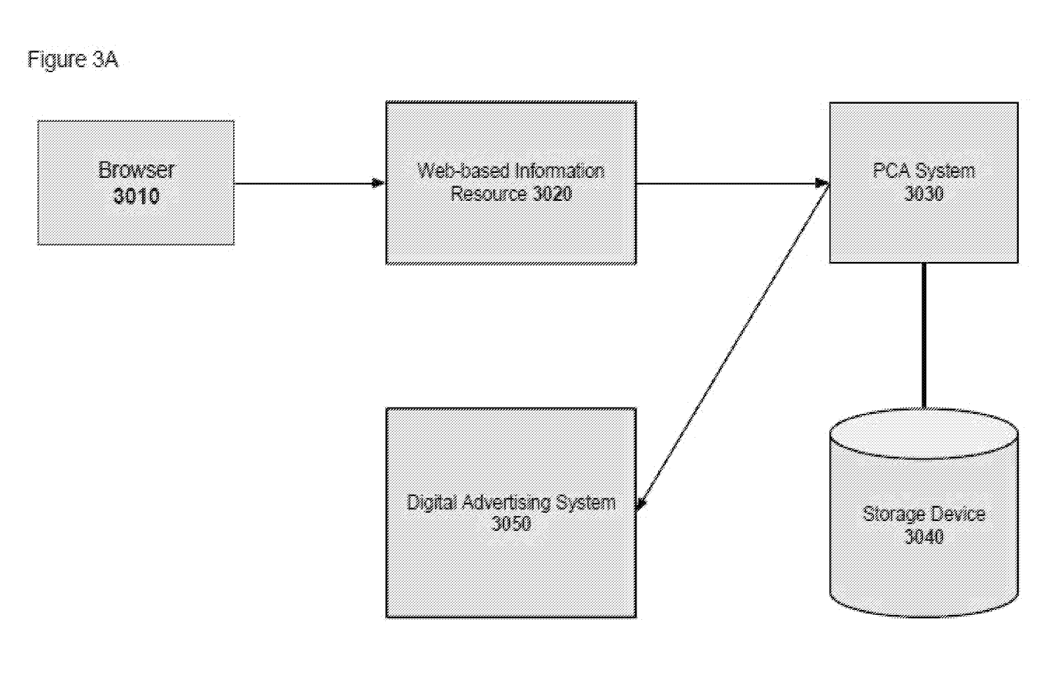

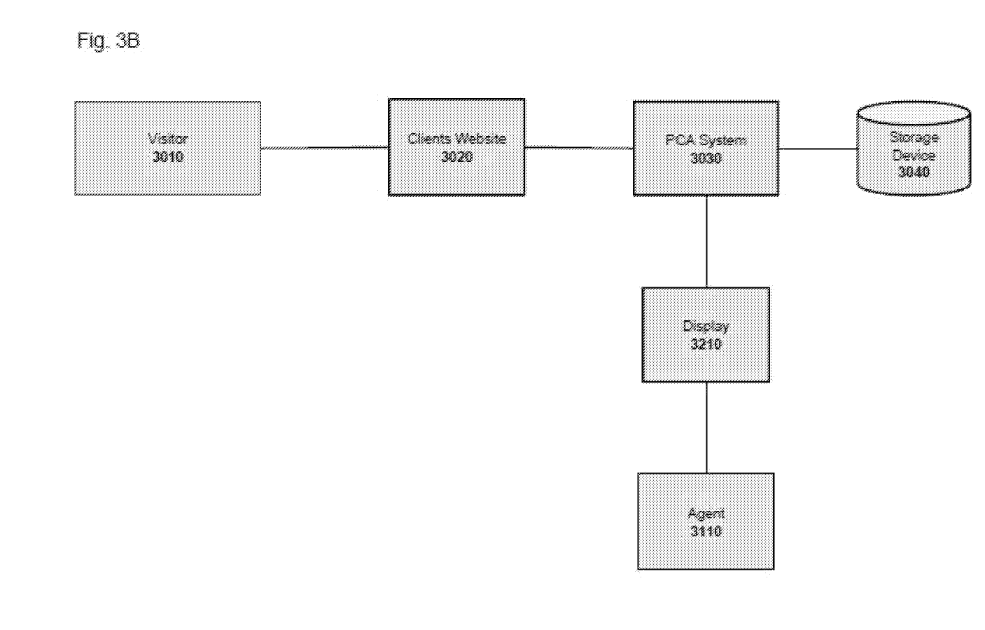

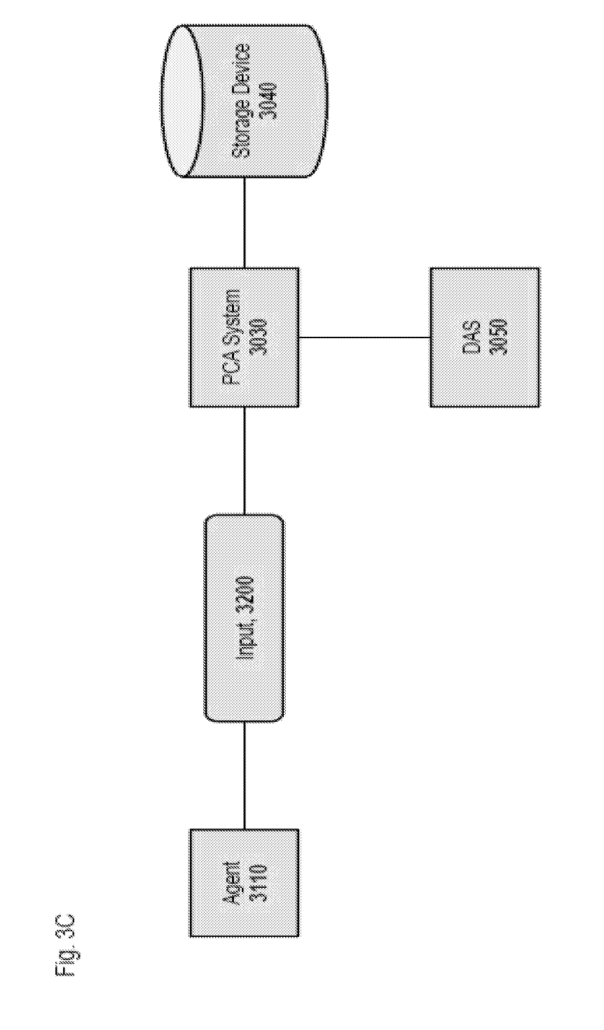

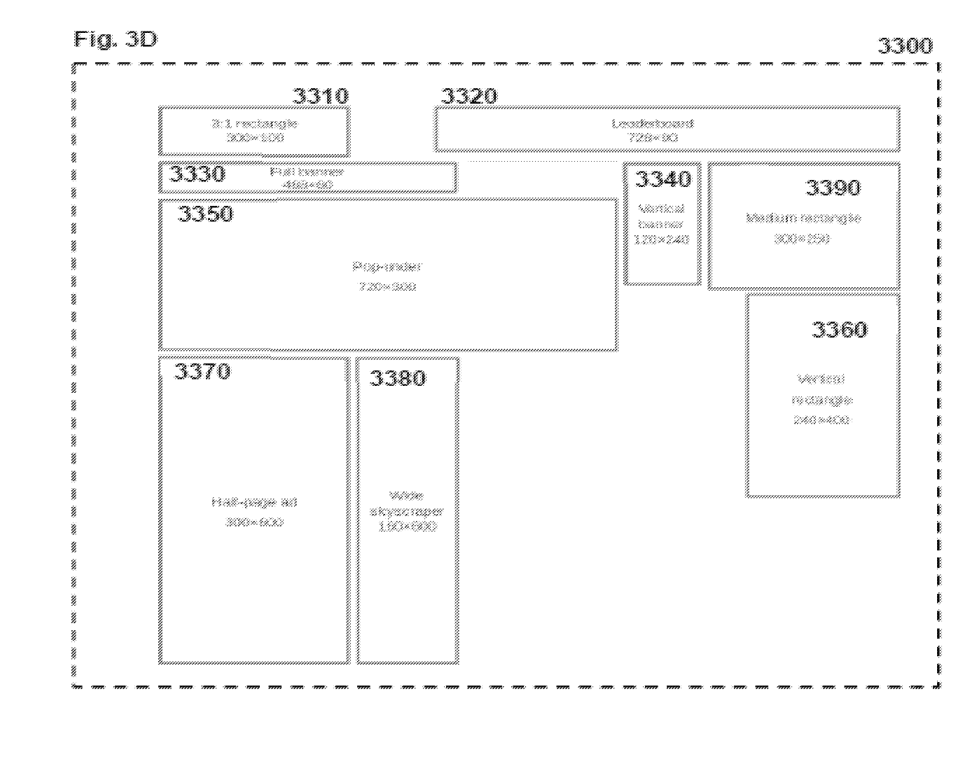

Referring now to FIG. 3A, a browser 3010 navigates to a web-based information resource 3020, such as a website. A browser refers generally to an application that is capable of rendering a web-based information resource, including the ability to render HTML and execute JavaScript functions. The term “visitor”, “user”, and “browser” are used interchangeably herein.

The website 3020 may include means to track the browser 3010, including but not limited to a browser identifier, in addition to behaviors taken by the visitor 3010. For instance, with website 3020 may include JavaScript code (the “PCA JS”) that communicates with a PCA System 3030, such as:

<script>
(function( ) {
var fks = document.createElement(′script′);
fks.type = ′text/javascript′;
fks.async = true;
fks.setAttribute(″wbir-userid″,″1″);
fks.setAttribute(″wbir-server″,″app.PCAsystem.com″);
fks.src = (′https:′ == document.location.protocol ? ′https://′:′http://′) +
′lkdjfai238920.cloudfront.net/assets/PCA.js′;
var s = document.getElementsByTagName(′script′)[0];
s.parentNode.insertBefore(fks, s);
})( );
</script>

The website 3020 may execute one or more Javascript functions that communicate the website's identity (e.g., by domain name or other parameters, such as “wbir-userid”) and zero or more visitor interactions (e.g., which HTML elements at the website were clicked if any, how much time was spent at the website, or what pages were visited).

Additionally, the PCA JS code may enable the website 3020 to generate a device ID (referred interchangeably as “fingerprint”) and communicate the fingerprint to the PCA System 3030. In another embodiment, the PCA System 3030 may transmit a PCA cookie to the website 3020, which may add that cookie to the browser 3010 for tracking purposes.

The website 3020 may also be configured (such as by executing PCA JS code) to parse URL parameters to access information, such as the campaign name, segment name, visitor ID from whence the ad unit referrer came (the “advertising unit data”). Further, the website 3020 may communicate the advertising unit data to the PCA System 3030.

The PCA System

The PCA System 3030 may consist of a web server that is coupled to a storage device 3040. For example, the PCA System 3030 may consist of an Amazon Web Services server and a PostgreSQL database 3040. In this embodiment, the web server and the storage device 3040 are connected via the Internet.

The PCA System 3030 may also communicate with a Digital Advertising System 3050 (a “DAS”). In particular, the PCA System 3030 may communicate with a DAS 3050 using an application programming interface (“API”). Via the API, the PCA System 3030 may cause the DAS 3050 to create an audience, a campaign, or ad unit. “Ad unit” refers to static or dynamic content for display via a digital advertising publisher, including but not limited to Rich Media Units, iFrames, images, streaming video, Flash™, HTML5, and others. An “audience” refers to a group of one or more visitors who should receive certain ad units associated to that audience. A “campaign” refers to a group of one or more audiences and one or more ad units at a DAS 3050 that share similar settings, such as budget, ad units, maximum cost per mile (CPM) bid, geographical targeting, and so on.

Likewise, the DAS 3050 may communicate with the PCA System 3030 to pass information such as the names of the audience and campaigns, in addition to cookies that the PCA System 3030 may communicate to the website 3020 and browser 3010.

The PCA System 3030 may receive information from one or more web-based information resources, such as a website 3020. The received information may include visitor 3010 tracking identifiers, such as a visitor's 3010 fingerprint, PCA cookie (the file itself, its contents, or some a hash of its contents), or a fingerprint and a PCA cookie. Additionally, the PCA System 3030 may receive information about a visitor's 3010 activities at a website 3020. The following table provides an example of information that may be received by the PCA System 3030:

| | |
|---|---|
| Fingerprint | 837492837 |
| Cookie Name | _PCA_session |
| Cookie Content | BAh7CEkiD3Nlc3Npb25faWQGOgZFVEkiJThmNzZmNjMwMWE5Y2E4 |
| | Njc0OWZjNjg4OWd2M2ExMDc4BjsAVEkiEF9jc3JmX3Rva2VuBjsARkki |
| | MW5uZW1x323djYXgwVVMrWm1wc0Jyd1lCdFNQdmI4MDJVNkd6eXZ |
| | 4WUVvckU9BjsARkkiGdafahcmRlbi51c2VyLnVzZXIua2V5BjsAVFsHW |
| | wZpMEkiIiQyYS428CQ2a2lFWk02RXYzT3NJMFBUN0IubEVPBjsAVA |
| Time on Website | 03:21 (mm:ss) |
| Pages Visited | Homepage, About Us, Demo Request |
| Clicks | Video play button, About Us link, Demo Request button |
| Forms Submitted | {First_name : “Sandeep”}, |
| | {Persona : “SaaS Product Leader”} |
| First Date of | Sep. 5, 2014 |
| Visit | |
| Number of | 3 |
| Repeat Visits | |

Additionally, the PCA System 3030 may access a storage device 3040 to record a visitor's 3010 tracking identifiers and/or activities at a website 3020. The storage device 3040 may include one or more tables 2020a, 2020b, 2030 capable of storing, among other things, a unique visitor ID, a fingerprint, visitor activities, segment name, campaign name, input 3200, and communication status. The storage device 3040 may also record advertising unit data, associating visitor 3010 interactions to that visitor's existing “visitor_id” and/or fingerprint, such as whether an ad unit was clicked.

The PCA System 3030 may communicate with a storage device 3040 to determine if a visitor's 3010 tracking identifiers exist at the storage device 3040. For instance, the PCA System 3030 may communicate the browser's 3010 fingerprint to a PostgreSQL database 3040. If the fingerprint or PCA cookie already exists, then the Visitor table 2020a may not create a new record or new audience name for the visitor 3010. If the fingerprint or PCA cookie does not exist in the PostgreSQL database 3040, then tables 2020a, 2030 may include a new record for the tracking identifier, create a new audience name (such as “audience_1”), and communicate the same to the PCA System 3030.

Presenting a Report

The PCA System 3030 may also generate a report for display. Presenting the report may be implemented in many ways. Referring now to FIG. 3B, in one embodiment, the report may be presented in email format, such as by sending the report to an agent 3110 for display at the agent's email application 3120. In another embodiment, the report may be prepared and displayed via a web application 3120, such as http://app.listenloop.com, or via integration with Salesforce's CRM web application. In other embodiments, the report may be presented via a mobile application 3120. For illustration purposes, an agent 3110 may be a sales representative for a product or service offered at the website 3020.

In another embodiment, an agent 3110 may be a computer with pre-defined outputs based on certain inputs. For instance, if a browser 3010 visited page1.html, then a computer agent 3110 may be presented with input, such as page loaded URL, CRM lead status, among other things. Based on said input or events, the computer agent 3110 may communicate instructions to the PCA System 3030 to display certain ad units.

Receiving Instructions from an Agent

Referring now to FIG. 3C, the PCA System 3030 may receive input 3200, such as text, images, or video. The input 3200 may be delivered to the PCA System 3030 via email, web application, mobile application, or other means of transmitting information to a server.

In some embodiments, an email message 3200 may be sent to a unique email address associated to the PCA System 3030 to distinguish the input 3200 from various agent-visitor sets. In another embodiment, the input 3200 may be communicated to the PCA System 3030 via integration with Salesforce.com's CRM web application. In some embodiments, the input 3200 may be human-generated, such as a message drafted based on a reported presented at a display 3120. In other embodiments, the input 3200 may be automatically generated based on information in the report. In other embodiments, a report presented to the agent 3110 may include means for input 3200, such as prompting the agent to reply to an email as the means for input 3200.

In other embodiments, a computer agent 3110 may be pre-configured to produce certain outputs in a PCA System 3030 based on visitor behavior or demographics. For instance, a PCA System 3030 may display an ad unit with message:
“Acme Co., thanks for requesting a demo. Consider downloading our white paper on how we've helped other anvil companies.”
   in response to a visitor submitting a demo request form after visiting the “/anvil.html” webpage and having CRM lead status, “Open.” Whereas another ad unit may convey:
“Acme Co., thanks for requesting a demo. Stay in touch with our newsletter and blogs.”
   in response to a visitor submitting a demo request form and having CRM lead status, “Unqualified.”

Advertising Units

Referring now to FIG. 3D, the PCA System 3030 may process input 3200 into one or more ad units 3300. For example, the PCA System 3030 may receive an email message input 3200, and some or all of the email text is converted into an image measuring 300×250 pixels—known as a “medium rectangle” ad unit 3390. This may be accomplished using open source libraries that convert text into an image, such as ImageMagick.

In other embodiments, the input may be converted into HTML that is displayed via an ad unit on a WBIR that supports advertising. Here, the PCA System 3030 need not convert text into images that serve as ad units. Further, in a PCA System 3030 that supports HTML content, an agent's 3110 instructions may be input in a template that produces HTML for the ad unit, such as:

```
  <p>{{#company_name}}<b>{{company_name}}</b>, {{/company_
  name}} We are helping companies like yours increase conversions
  rates on anonymous website visitors into booked meetings.</p>
  <img src=″http://app.listenloop.com/assets/free-consult.jpg″></img>
<p>Get your free consultation here.</p>
```

Furthermore, the PCA System 3030 may create a plurality of ad units 3300 from input 3200, such as 3:1 rectangle (300×100) 3310, a leaderboard (728×90) 3320, a full banner (468×60) 3330, a vertical banner (120×240) 3340, a pop-under (720×300) 3350, a vertical rectangle (240×400) 3360, a half-page ad (300×600) 3370, a wide skyscraper (160×600) 3380, a medium rectangle (300×250) 3390, and so on. For each different size ad unit, the PCA System 3030 may format and/or transform the input 3200 to fit within the pixel limits of the ad unit in a pleasing way. In some embodiments, the ad units 3300 may include additional text and/or graphics beyond the email message input 3200, such as a logo or background color. Such additional elements may be specified in the input 3200, by including, for instance, the following text in a message “##background-color:blue; logo:imagel.png”. Alternatively, additional parameters, such as “background-color” and other image stylings may be input through a web or mobile application interface.

Turning to FIG. 3C, the input 3200 may also include a URL that identifies the landing page (e.g., href) if an ad unit is clicked. The input 3200 may include a URL within the message itself, such as.
Hi ACME Co., thanks for visiting our blog. I'd love to show you how you can increase customer engagement using ListenLoop.com. Let's schedule a demo. Are you free next week at 10 am PST?
-Rodrigo
##url: http://listenloop.com/demo

Alternatively, the URL parameter for one or more ad units may be input through a web or mobile application interface. In some embodiments, where a landing page URL is not provided, a pre-determined or dynamically generated URL may be used.

In another embodiment, the PCA System 3030 may receive audio and/or video input 3200, which the PCA System 3030 may process and convert into one or more ad units 3300 in appropriate formats, such as Rich Media Unit, In-Stream Video Ads, HTML5, or Flash™

Advertising Campaigns

In certain embodiments, such as when the PCA System 3030 interfaces with a demand side platform DAS 3050, the PCA System 3030 may be configured to generate a campaign name.

In one embodiment, the PCA System 3030 creates a campaign name for each unique pair of input 3200 and visitor ID or fingerprint. The PCA System 3030 may communicate the campaign name to a storage device 3040, associating the input 3200, the campaign name, a visitor ID, one or more fingerprints, and one or more visitor behaviors.

In another embodiment, the PCA System 3030 creates a campaign name and segment to message a plurality a browsers. Here, the ad unit is an ad tag, rather than an image, that can check a browser's cookies to determine which creative should be delivered. For instance, this is a possible ad tag for a 300×250 ad unit:

<script language=″JavaScript″
src=″http://adserver.listenloop.com/tag.jsp?pid=F53G1D3DB&w=
300&h=250&r
w=1&xurl={pageUrl}&sid={siteId}&rnd={ts}&cm={clickMacro}″>
</script>

When that ad tag loads at a WBIR that support advertising, it may read the browser cookies, fingerprints, or device ID to determine what content to display for that browser.

Communications with a Digital Advertising System

The PCA System 3030 may communicate one or more ad units, landing page URLs, audience names, and/or campaign names to the DAS 3050. This may be achieved using an API, browser scripting, or other means.

In general, the PCA System 3030 may be configured to cause a DAS 3050 to create, pause, update, or delete a campaign, audience, and/or ad units associated to the visitor 3010, which may be in response to an indication that certain criteria have been met. Similarly, the PCA System 3030 may be configured to cause a DAS 3050 to display a second advertising unit to the visitor 3010, which may be in response to an indication that certain criteria have been met. This may be achieved using an API, browser scripting, or other means.

The PCA System 3030 may be configured to create, pause, update, or delete a campaign, audience, and/or ad unit may if one or more of the following criteria are met:
the ad unit was displayed to the visitor 3010 N-times;
the visitor 3010 interacted with a displayed ad unit N-times;
the visitor 3010 navigated to the website 3020 and took an action, such as submitting an online form for a demo request;
the visitor 3010 has not interacted with a displayed ad unit in N-days;
the agent associated to the website 3020 indicates that the ad unit should not be displayed; and/or
the visitor's 3010 data corresponding to its CRM record reflected a particular value, such as “Lead Status=MQL.”

Many other criteria are possible, and the foregoing list provides a few non-limiting examples.

The PCA System 3030 may be configured to use criteria, like the foregoing list, to cause a second advertising unit to display at a web-based information resource that supports advertising.

In this way, “workflows” may be created so that an agent 3110 can create a sequence of messages 3200 for display to a visitor 3010.

Digital Advertising System

The DAS 3050 refers generally to a system that may display digital advertising to a visitor 3010 if identified by tracking means, such as cookies. For instance, a DAS 3050 may consist of a real-time bidding (“RTB”) system, where advertising buyers programmatically bid on an impression for a particular visitor 3010 and, if the bid is won, the buyer's ad is displayed on the publisher's site to that visitor 3010 in real-time or near real-time.

Many embodiments are possible, such as where the DAS 3050 consists of a demand side platform (“DSP”) with the ability to track a visitor 3010 and purchase advertising inventory for that visitor's 3010 impressions at a web-based information resource that supports advertising. In another embodiment, the DAS 3050 consists of one or more ad exchanges with the ability to purchase advertising inventory with respect to a particular visitor 3010. In other embodiments, the DAS 3050 may purchase advertising inventory directly from a supply side platform or directly with a publisher with respect to a particular visitor 3010.

In one embodiment, the DAS 3050 may create a campaign. For example, the DAS 3050 may receive API commands from a PCA System 3030 to create a campaign with a specific name or title. Note that in some DAS 3050, a “campaign” may be referred to as an “ad group”.

The DAS 3050 may also create an audience. For instance, the DAS 3050 may receive API commands from a PCA System 3030 to create an audience with a specific name or title. Note that in some DAS 3050, an “audience” may be referred to as a “segment” or “ad segment”.

Likewise, the DAS 3050 may create one or more ad units (the “DAS ad units”). For instance, the DAS 3050 may receive API commands from a PCA System 3030 to create a DAS ad unit based on a landing page URL and ad unit 3300. Many embodiments are possible, such as where a DAS 3050 creates a DAS ad unit based on a landing page URL and a Rich Media Unit, streaming video, or Flash ad unit 3300. In some embodiments, a landing page URL may not be required to create a DAS ad unit. In some embodiments, DAS ad units may require approval before such DAS ad units are active and available for delivery to a WBIR that supports advertising.

The DAS 3050 may add one or more audiences to one or more campaigns. By way of example, the DAS 3050 may receive API commands from a PCA System 3030 to add an audience, titled “Sandeep”, to a campaign, titled “2387129-listenloop.com”.

The DAS 3050 may add one or more DAS ad units to one or more campaigns. By way of example, the DAS 3050 may receive API commands from a PCA System 3030 to add certain DAS ad units to campaign “2387129-listenloop.com”.

The DAS 3050 may receive instructions to create, read, update, or delete a campaign, audience, and/or ad unit may if one or more of the following criteria are met:
the ad unit was displayed to the visitor 3010 N-times;
the visitor 3010 interacted with a displayed ad unit N-times;
the visitor 3010 navigated to the website 3020 and took an action, such as submitting an online form for a demo request;
the visitor 3010 has not interacted with a displayed ad unit in N-days; and/or
the agent associated to the website 3020 indicates that the ad unit should not be displayed; and/or
the visitor's 3010 data corresponding to its CRM record reflected a particular value, such as “Lead Status=MQL.”

### Indication to Display an Advertising Unit

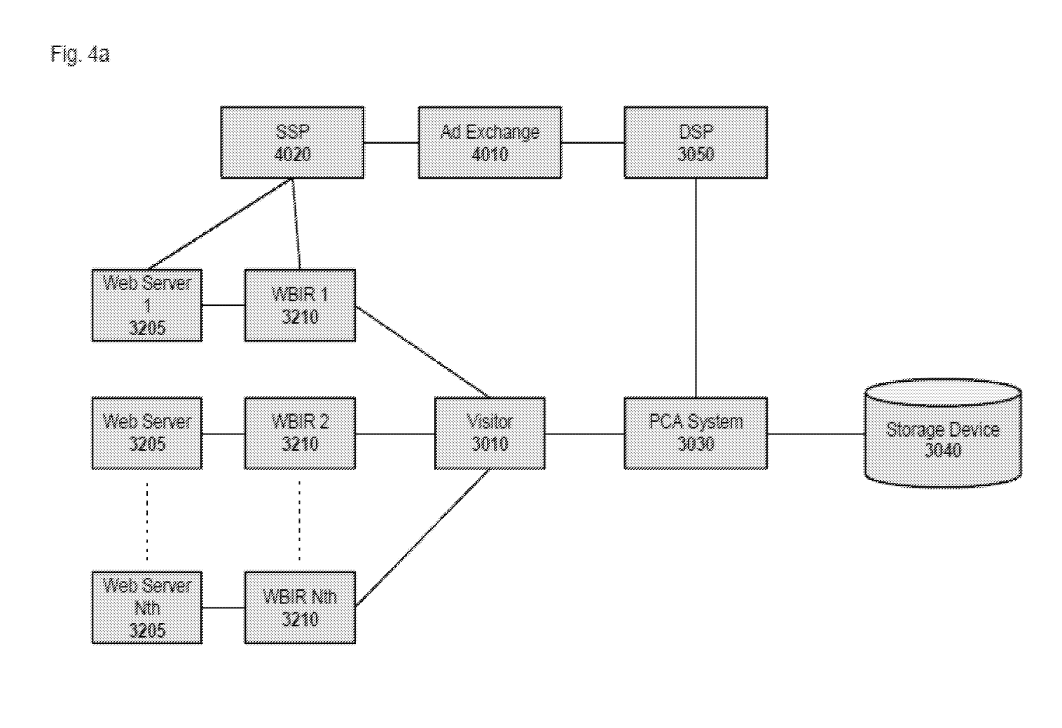

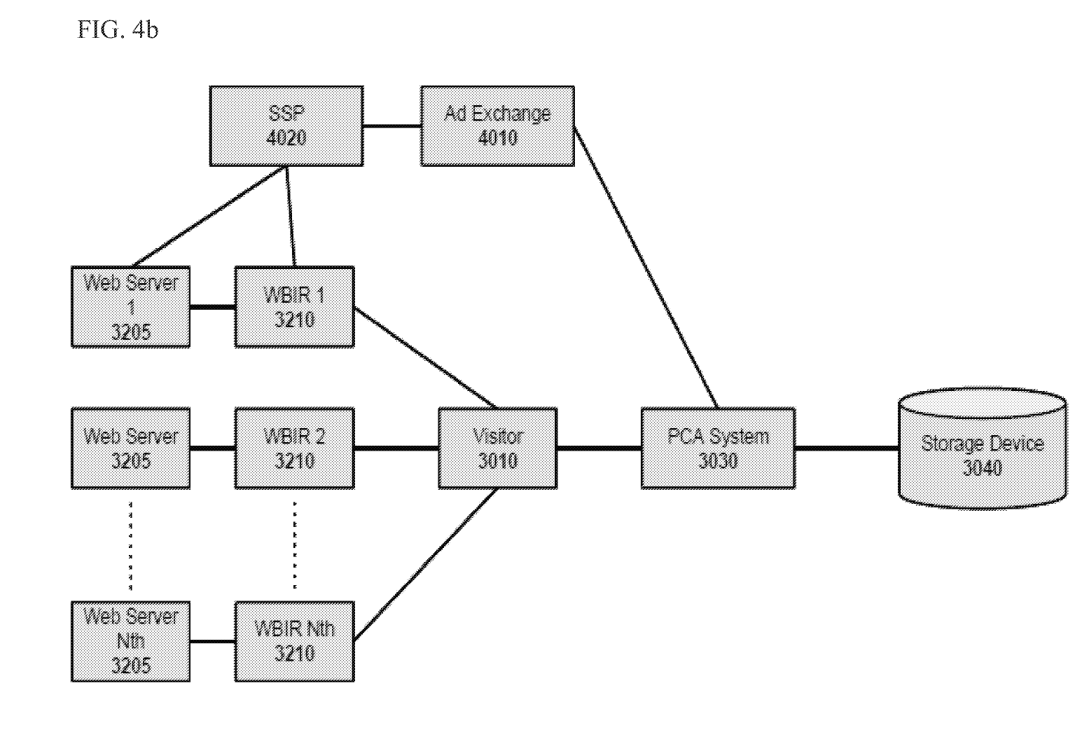

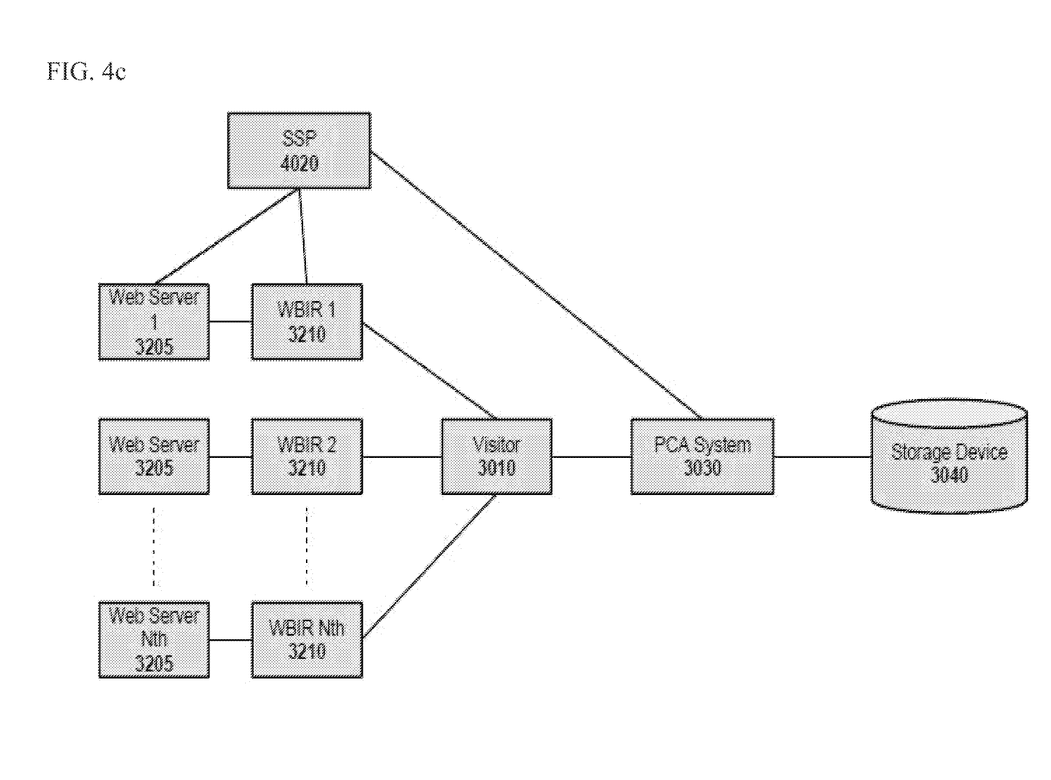

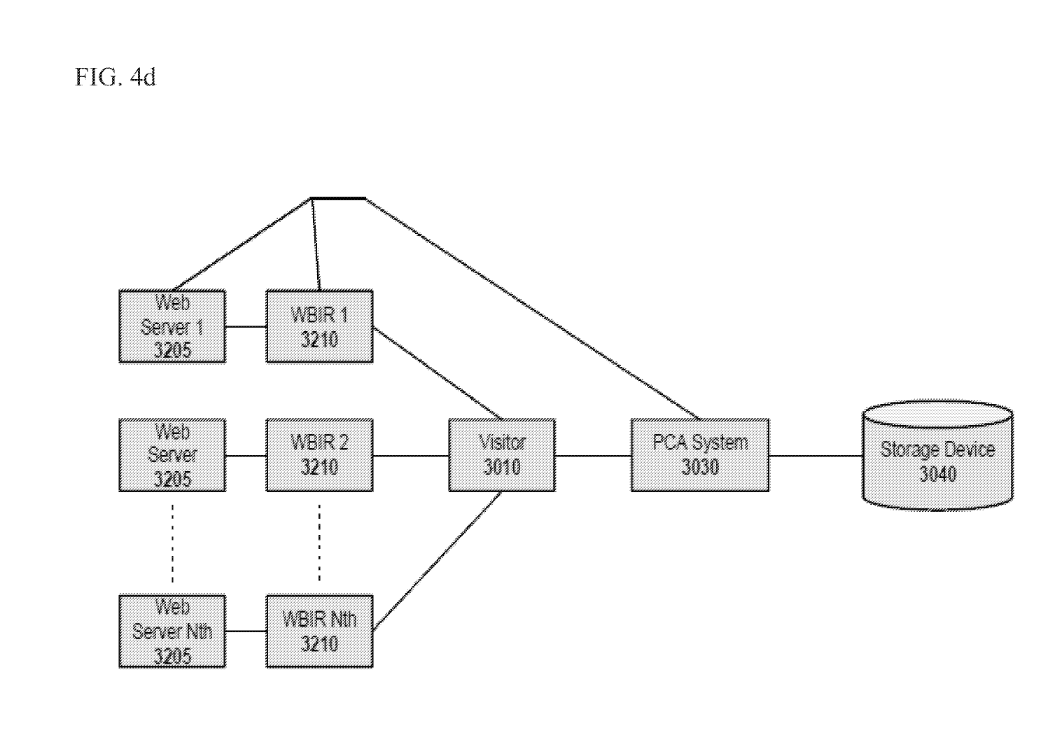

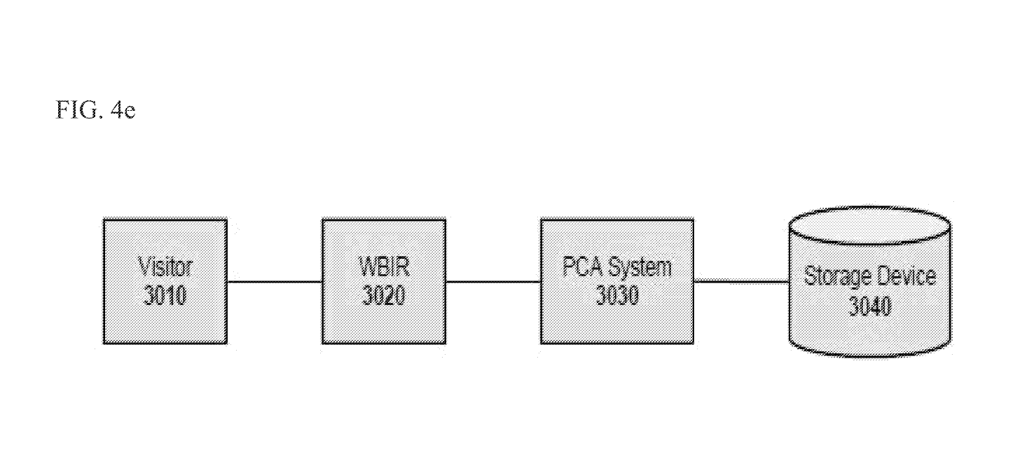

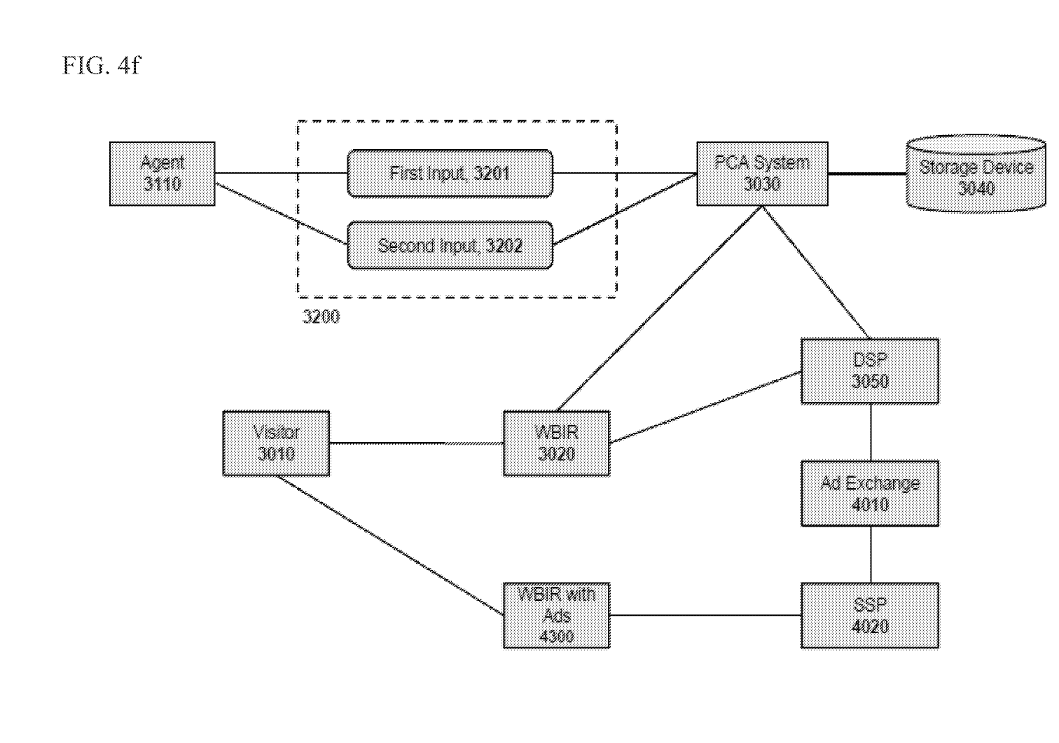

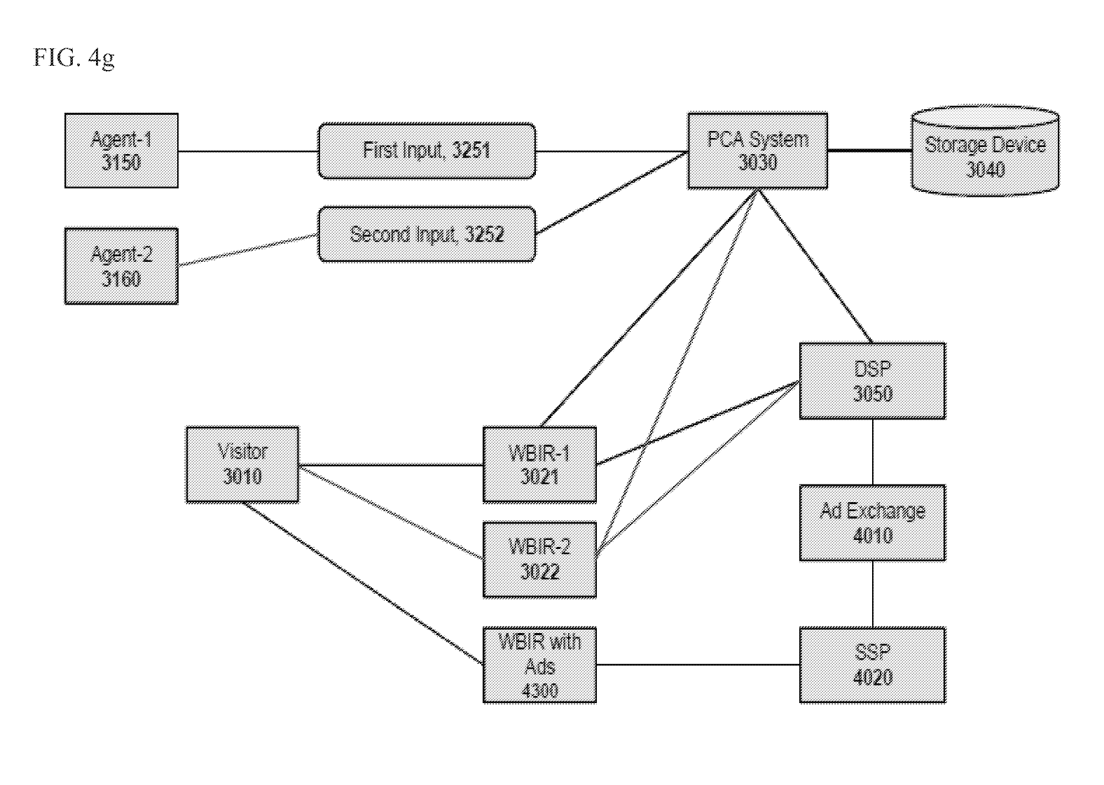

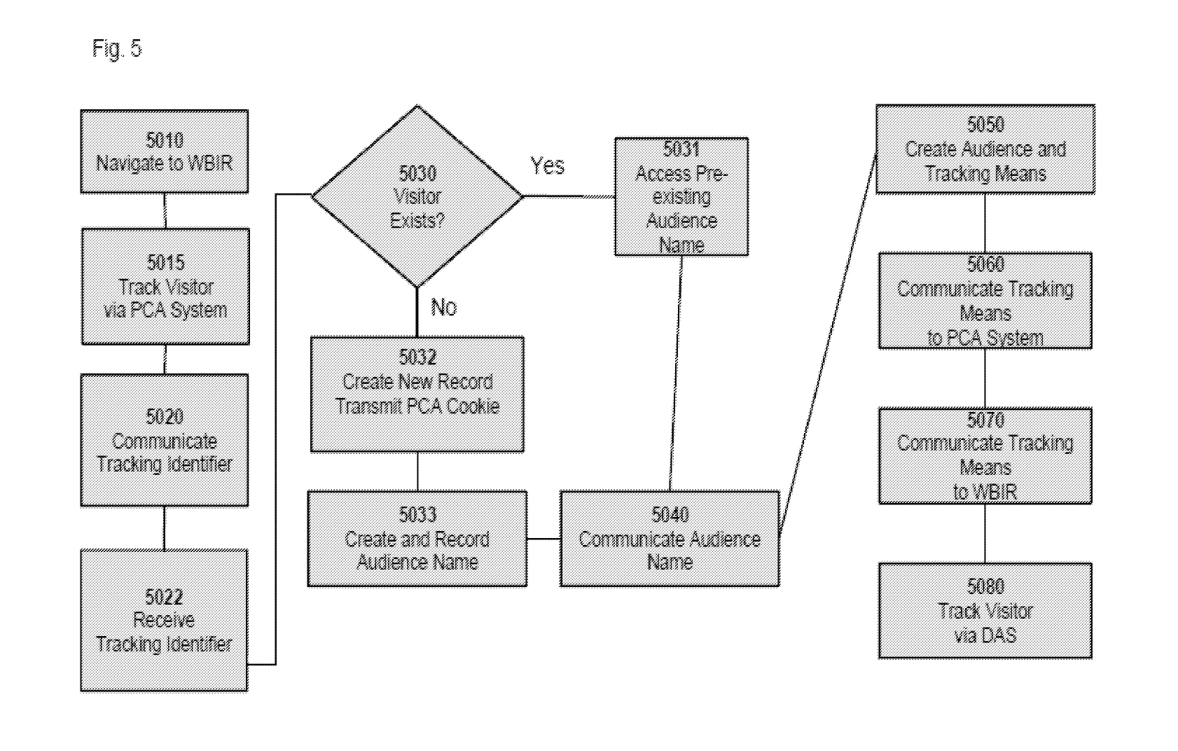

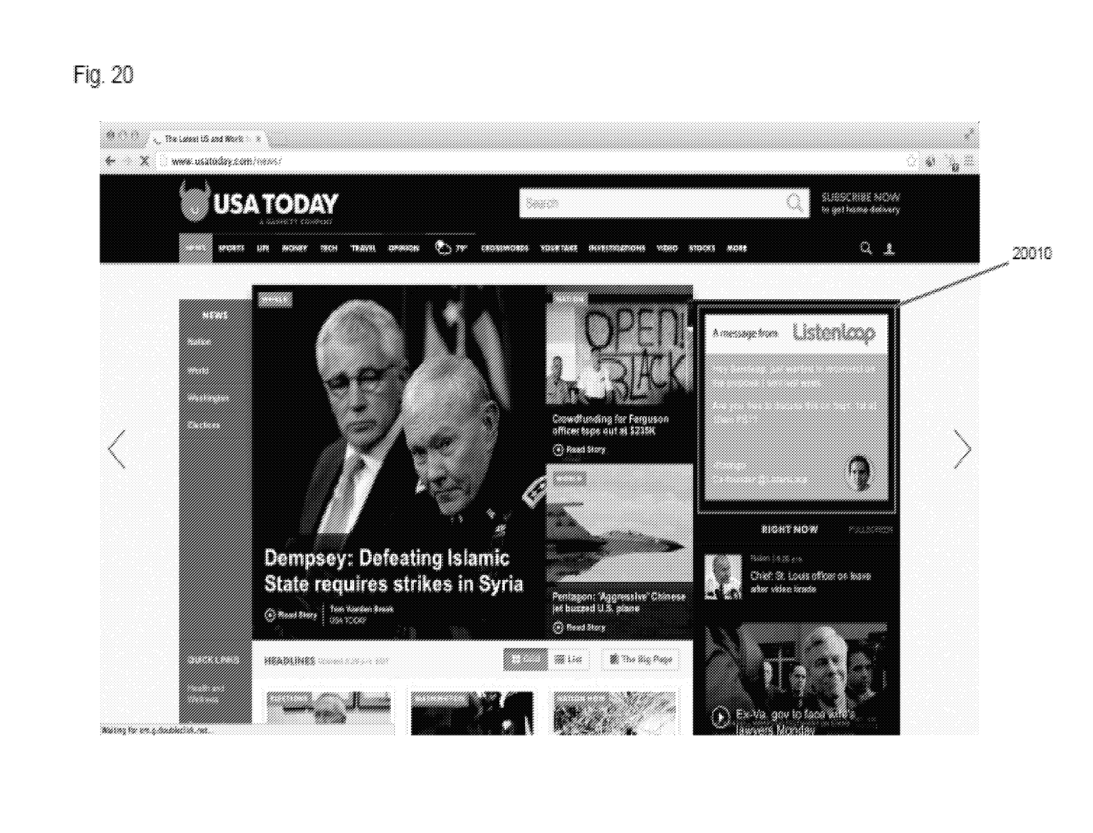

Referring now to FIG. 4a, there is a plurality of web servers 3205 coupled to the visitor 3010 via a computer-based network. Each web server hosts a web-based information resource 3210. One or more of the web-based information resources supports advertising. For example, a web browser 3010 navigates to www.USAToday.com 3210, which supports digital advertising in certain areas of its website (see FIG. 20).

The plurality of web servers 3205 and/or the web-based information resources 3210 are configured such that an advertising unit may be displayed only in response to an indication that the person 3010 is visiting one of the web-based information resources that support advertising 3210.

In one embodiment, a visitor 3010 navigates their web browser to the website USAToday.com 3210. In some embodiments, a DAS cookie is available at the browser 3010, such as where the PCA System 3030 executes JavaScript code at the browser 3010 that causes the DAS 3050 to communicate a cookie to the browser 3010. Here, the PCA System 3030 may access a storage device 3040 to associate the DAS cookie, PCA cookie, and/or fingerprint.

The web-based information resource, USAToday.com 3210, may execute code that reads a DAS cookie if one is available on the visitor's web browser 3010. The website 3210 or web server 3205 may transmit the DAS cookie (or an identifier of the DAS cookie, such as a MD5 hash of its content) to an advertising exchange 4010 through a supply side platform (“SSP”) 4020.

The ad exchange 4010 may communicate the DAS cookie (or an identifier of the DAS cookie) to one or more demand side platforms (“DSP”) 3050. Indications are provided if the DAS cookie (or its identifier) matches, or not, a record in a DSP 3050. If there is an indication that there is a match, the demand side platform may programmatically bid on an impression for that particular visitor 3010. If there is an indication that there is no match, the demand side platform may forego bidding on the impression for that particular visitor 3010. In the absence of an indication that there is a match, the DSP may forego bidding on the impression for that particular visitor 3010. If DSP 3050 bids and wins the auction for the impression, then a DAS ad unit associated to the visitor 3010 may be displayed at USAToday.com 3210.

Many other embodiments are possible, such as in FIG. 4c, where the foregoing system omits a DSP, and the ad exchange 4010 provides an indication that the person 3010 is visiting one of the web-based information resources that support advertising 3210. In some embodiments, such as in FIG. 4d, a system omits a DSP 3050 and an ad exchange 4010, and the SSP 4010 may provide an indication that the person 3010 is visiting one of the web-based information resources that support advertising 3210. FIG. 4e presents yet another embodiment, where the foregoing system omits a DSP 3050, an ad exchange 4010, and a SSP 4020, the web server 3205 or WBIR 3210 may provide an indication that the person 3010 is visiting one of the web-based information resources that support advertising 3210.

Repeat Visits to a Website

In one embodiment, the PCA System 3030 may create one record for each set of visitor 3010—website 3020 pairs to control data management at the storage device 3040.

Turning now to FIG. 4f, a visitor 3010 may visit a web-based information resource 3020 more than once. For instance, a person navigates their browser 3010 to the website www.WorkMarket.com 3020 on Sep. 16, 2014 for the first time (the “first visit”) and then again on Oct. 14, 2014 (the “next visit”).

The website 3020 may be configured to generate and communicate the visitor's 3010 fingerprint to the PCA System 3030. In another embodiment, the website 3020 may access a PCA cookie if one is available from the visitor 3010. The website 3020 may communicate the PCA cookie, its contents, or some identifier for the PCA cookie (e.g., a MD5 hash) to the PCA System 3030.

The PCA System 3030 may receive tracking identifiers for the visitor 3010, such as the fingerprint, the PCA cookie, or the fingerprint and the PCA cookie. The PCA System 3030 may query a storage device 3040 to determine if the tracking identifiers exist at the storage device 3040. For instance, the PCA System 3030 may communicate the browser 3010 fingerprint to a PostgreSQL database 3040. If the fingerprint or PCA cookie already exists, then the storage device may not create a new record or new audience name.

Multiple Agent Communications to a Visitor

Turning now to FIG. 4g, an agent 3110 may provide a plurality of input 3200. For instance, suppose that an agent 3110 inputs a first message 3201, such as “Hi Joe, thanks for visiting our blog at WorkMarket.com. Click here to download our eBook.” A few days later, the agent 3110 inputs a second message 3202, “Hey Joe, just wanted to check-in. Would you like a demo of our software?”

Many embodiments are possible to handle such circumstances, including but not limited to:
(i) causing a first advertising unit based on the first message to stop displaying at a web-based information resource that supports advertising and causing a second advertising unit based on the second message to be displayed at a web-based information resource that supports advertising;
(ii) causing a plurality of advertising units based on a plurality of messages to be displayed simultaneously at a web-based information resource that supports advertising; or
(iii) causing a plurality of advertising units based on a plurality of messages to be displayed in a particular sequence at a web-based information resource that supports advertising based on meeting certain criteria.

In one embodiment, the agent 3110 inputs a first message 3201 and a second message 3202 to the PCA System 3030. Each input 3201, 3202 may include identifier information for a visitor 3010 at a WBIR 3020, such as an audience name, visitor ID, fingerprint, and/or PCA cookie. The PCA System may convert the plurality of inputs 3201, 3202 into a plurality of ad units.

For each input 3201, 3202, the PCA System 3030 may generate new campaign names (e.g., “first campaign” and “second campaign” corresponding to the first message and second message). The PCA System 3030 may record the campaign names in a storage device 3040, associating the campaign names to a visitor 3010. The PCA System 3030 may communicate with a DAS 3050, causing the DAS 3050 to create corresponding campaigns and DAS ad units.

In one embodiment, the DSP 3050 may create, read, update, or delete the first campaign and activate the second campaign, such that a first advertising unit based on the first message may not display at a web-based information resource that supports advertising 4300 while a second advertising unit based on the second message may be displayed at a web-based information resource that supports advertising 4300.

In another embodiment, the DSP 3050 may delete the first DAS ad unit, such that a first advertising unit based on the first message may not display at a web-based information resource that supports advertising 4300 while a second advertising unit based on the second message may be displayed at a web-based information resource that supports advertising 4300.

In some embodiments, the DSP 3050 may not delete, update, or pause the first campaign, such that a first advertising unit based on the first message may be displayed at a web-based information resource that supports advertising 4300 while a second advertising unit based on the second message may be displayed at a web-based information resource that supports advertising 4300. Here, the first and second advertising units may be displayed simultaneously at a web-based information resource that supports advertising 4300.

In other embodiments, the PCA System 3030 may execute commands that coordinate the creating, reading, updating, deleting, or activation of the first or second campaign at the DSP 3050 based on certain criteria (see, e.g., step 8034a,b for exemplary criteria), such that a plurality of advertising units based on a plurality of messages are displayed in a particular sequence at a web-based information resource that supports advertising 4300.

Turning to FIG. 4h, in some cases, a visitor 3010 may visit a plurality of websites 3021, 3022 that are coupled to a PCA System 3030. The PCA System 3030 may coordinate the creating, reading, updating, deleting, or activation of the first or second campaign at the DSP 3050 based on certain criteria (see below for exemplary criteria), such that a plurality of advertising units based on a plurality of messages from different agents 3150, 3160 from different websites 3021, 3022 are displayed simultaneously or in a particular sequence to a visitor 3010 at a web-based information resource that supports advertising 4300. For example, the PCA System 3030 may cause the first ad unit based on first input 3251 to be displayed, rather than the second ad unit based on the second input 3252 to be displayed, if one or more of the following criteria are met:
the first ad units were created before the second ad unit;
the first ad unit has a higher cost per mile (CPM) bid amount than the second ad unit;
the second ad unit has exhausted its frequency cap;
the second ad unit may not be displayed at the time the visitor navigated to the website that supports advertising;
the second ad unit may not be displayed at the geographical location for the visitor 3010; and
the second ad unit is not eligible to be displayed at the website that supports advertising.

In another embodiment, the PCA System 3030 may allow or instruct the DAS 3050 to use its own logic to control whether the first or second ad unit should be displayed.

Other implementations similar to the embodiments above are possible, such as by omitting a DSP 3050, ad exchange 4010, and/or SSP 4020 to display one or more advertising units at a web-based information resource that supports advertising 4300.

Method for Tracking Activities

In step 5010, a browser 3010 navigates to a website 3020. In step 5015, the website 3020 executes code by which to track the browser 3010, such as adding a cookie to the browser or generating a fingerprint. In step 5020, the website 3020 communicates with a PCA System 3030, transmitting the fingerprint and/or cookie information (the “tracking identifier”). Step 5022 receives the tracking identifier data, and in some embodiments, parses the tracking identifier data.

Step 5030 determines whether the tracking identifier data is known to the PCA System 3030 or otherwise exists in a storage device 3040. For example, the PCA System 3030 may communicate the browser 3010 fingerprint to a PostgreSQL database. If the fingerprint already exists, then step 5031 will not create a new record and it will access an audience name associated to the fingerprint. Otherwise, step 5032 will add a record to the storage device 3040 for the new fingerprint. Step 5032 may also send a PCA cookie with visitor id to the visitor 3010.

Step 5033 may create a new audience name (such as “audience 1”), and store that audience name in the storage device 3040. Step 5040 may communicate the audience name to the DAS 3050. By way of example, the PCA System web server 3030 may execute API commands that transmit the audience name to a demand side platform 3050.

In step 5050, the DAS 3050 creates a new audience and corresponding tracking means (the “DAS tracking means”). In this embodiment, the audience corresponds to the audience name in the storage device 3040. In one implementation, the tracking means corresponding to the audience may be executed via JavaScript that adds a cookie to a browser 3010, such as this:

<script type=″text/javascript″>var ssaUrl = (′https:′ == document.
location.protocol ?
′https://′ : ′http ://′) + ′pixel.SomeDSP.com/iap/28be091a87dcbd9a′;
new Image( ).src =
ssaUrl;</script>

In other embodiments, the audience name can be any alpha-numerical string, as long as there is an ability to relate audience names within the storage device 3040 and the DAS 3050.

Step 5060 communicates part or all of the tracking means—for example, “pixel.SomeDSP.com/iap/28be091a87dcbd9a”—to the PCA System 3030. This step may be achieved using an API, browser scripting, or other means.

Step 5070 communicates the DAS tracking means to the website 3020. Step 5080 adds the DAS tracking means to the browser 3010. This step may be accomplished, for instance, by executing client-side JavaScript that executes the following:

<script type=″text/javascript″>var ssaUrl = (′https:′ == document.
location.protocol ?
′https://′ : ′http://′) + ′pixel.SomeDSP.com/iap/28be091a87dcbd9a′;
new Image( ).src =
ssaUrl;</script>

In other embodiments, the audience name need not be unique to each browser. Here, Step 5033 may add one or more browsers to an existing audience name (such as “bucket_1”).

Method for Receiving Instructions from an Agent

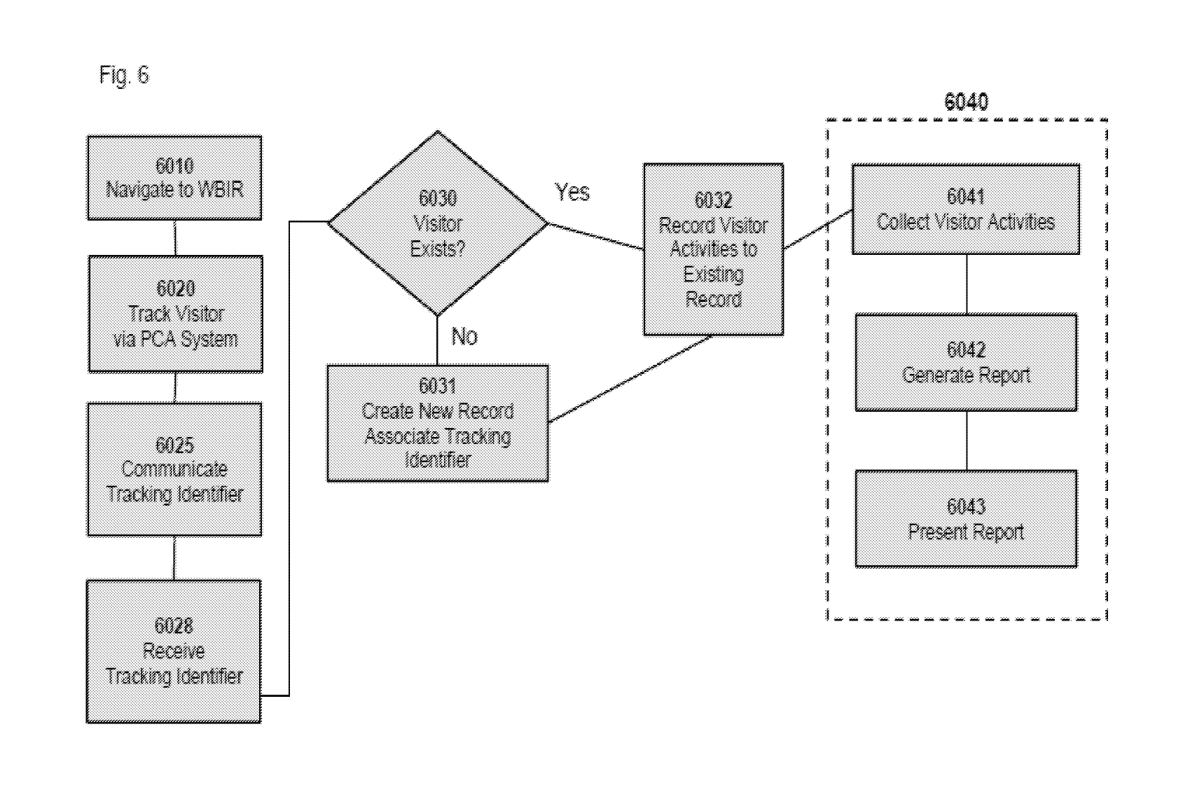

Referring now to FIG. 6, in step 6010, a visitor 3010 navigates to a website 3020. Step 6020 executes tracking means that adds an identifier to the visitor 3010, and step 6025 communicates the same to the PCA System 3030. Step 6028 receives one or more tracking identifiers, such as a fingerprint and/or cookie. In one embodiment, step 6020 generates a fingerprint for visitor 3010, step 6025 executes JavaScript to send the fingerprint to the PCA System 3030, and the PCA System 3030 receives the fingerprint.

Step 6030 determines whether the tracking identifier data is known to the PCA System 3030 or otherwise exists in a storage device 3040. In one embodiment, the PCA System 3030 may query a PostgreSQL database 3040 for a fingerprint tracking identifier. If that fingerprint is not present, step 6031 creates a new visitor record and associates the tracking identifier to that Visitor, and proceeds to step 6032. If the tracking means identifier is present, step 6032 records information at the storage device 3040 about the visitor 3010 at the website 3020, such as “time on website”, “pages visited”, “click locations”, “forms data submitted”, among other things.

Step 6040 compiles information about a visitor's 3010 behavior at a website 3020, prepares a report, and presents said report to an agent 3110. In this embodiment, step 6041 queries the storage device 3040 for the fingerprint associated to the visitor 3010, pulling information such as “time on website”, “pages visited”, “click locations”, “forms data submitted”, among other things for that visitor 3010. Step 6042 generates a report about visitor 3010, optionally including information from the storage device 3040 about visitor 3010. Said report may be formatted in various ways, such as in a web application dashboard or via email. Step 6043 presents the report to an agent 6110, such as by communicating the report through an email, web application, or mobile application.

Method for Creating Advertising Units

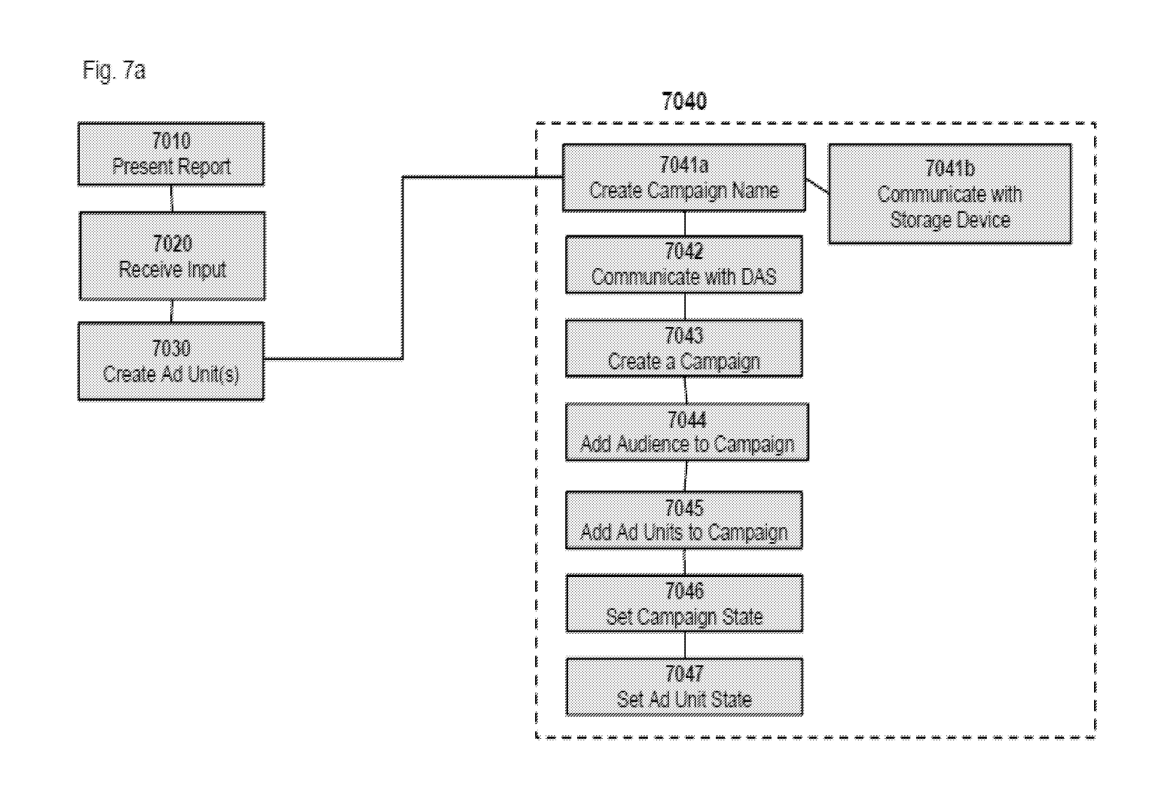

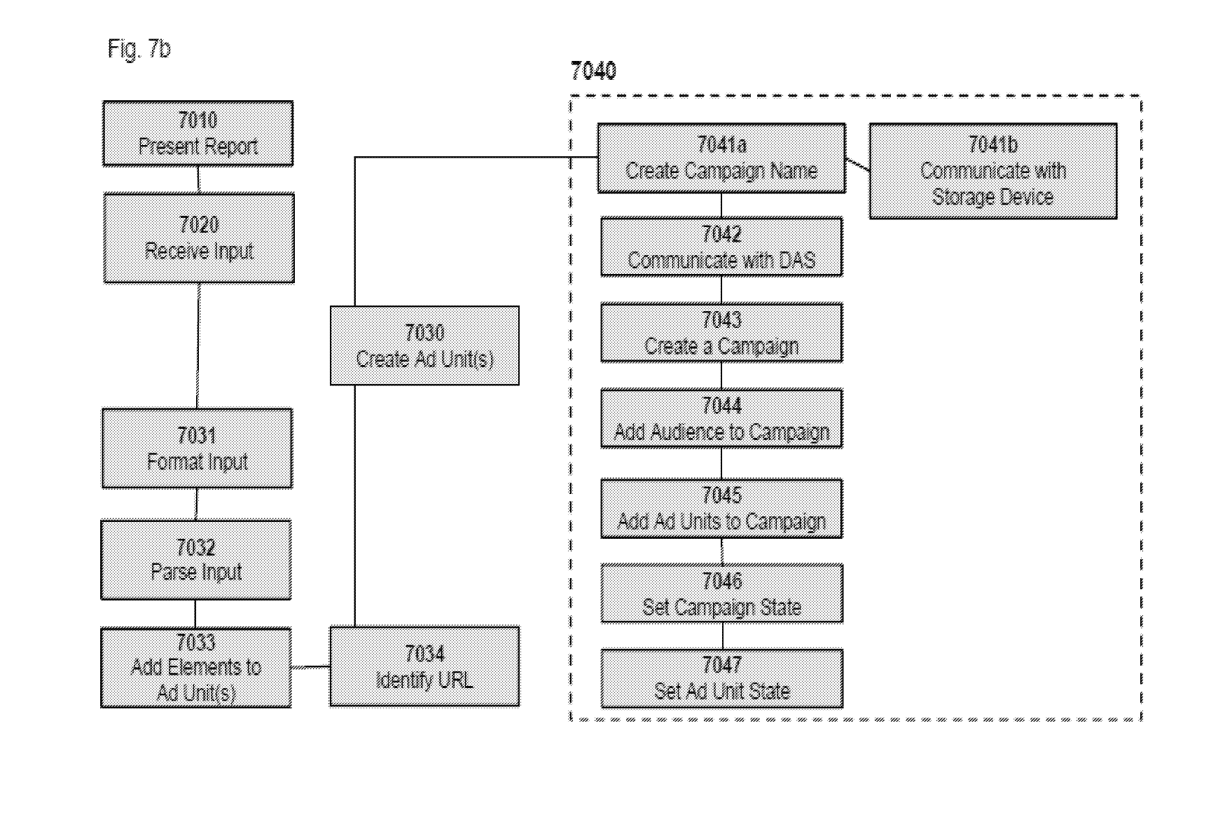

Turning now to FIG. 7a, some embodiments may include step 7010, wherein an agent 3110 may be presented with a report, where that report allows the agent 3110 to provide input 3200. For instance, an agent 3110 may receive and view an email generated or sent by the PCA System 3030, where that email provides a report about a visitor's 3010 behavior at a website 3020, and where a reply to that email comprises input 3200.

Step 7020 receives the input 3200 at the PCA System 3030. Continuing the example above, the agent's 3110 message 3200 is received by the PCA System 3030 via a mailto: or reply-to: email address that is associated to the PCA System 3030.

In step 7030, the PCA System 3030 may create one or more ad unit based on the message 3200. By way of example, the PCA System 3030 may receive email message input 3200, and in step 7030, some or all of the email text is converted into an image measuring 300×250 pixels—known as the “medium rectangle” ad unit 3390. In another embodiment, the PCA System 3030 receives audio and/or video input 3200, and step 7030 processes and converts that input 3200 into one or more ad units 3300 in audio or visual formats, such as Rich Media Unit, In-Stream Video Ads, HTML5, or Flash™.

Step 7040 causes the ad unit to be displayed at one or more webpages or websites that support advertising, only in response to an indication that the visitor 3010 is visiting a website that supports advertising. In one embodiment, step 7040 consists of several substeps 7041-7047.

Step 7041a creates a campaign name. In another embodiment, step 7041a creates a campaign name for each unique pair of input 3200 and fingerprint. Step 7041b communicates the campaign name to a storage device 3040, associating the input 3200, the campaign name, a visitor ID, one or more fingerprints, and one or more visitor 3010 activities.

In other embodiments, the input may be converted into HTML that is displayed via an ad unit on a WBIR that supports advertising. Here, the PCA System 3030 need not convert text into images that serve as ad units. Further, in a PCA System 3030 that supports HTML content, an agent's 3110 instructions may be input in a template that produces HTML for the ad unit, such as:

<p>{{#company_name}}<b>{{company_name}}</b>, {{/company_name}}
We are helping companies like yours increase conversions rates on
anonymous website visitors into booked meetings.</p>
<img src=″http://app.listenloop.com/assets/free-consult.jpg″></img>
<p>Get your free consultation here.</p>

Step 7042 communicates instructions to a DAS 3050, including information such as one or more ad units 3300, landing page URLs, audience names, and campaign names, bid information, days to run, inventory publishers who may display the ad unit, or any other properties required by DAS 3050 to run a campaign. This may be achieved using with an API, browser scripting, or other means.

In one embodiment, step 7043 causes the DAS 3050 to create a campaign. For example, the DAS 3050 may receive API commands from a PCA System 3030 to create a campaign with a specific name or title. However, in some embodiments, step 7043 is not necessary, such as where the DAS does not use a “campaigns” concept.

Step 7044 causes the DAS 3050 to add an audience to a campaign. For instance, the DAS 3050 may receive API commands from a PCA System 3030 to add an audience with a specific name or title to a campaign. In one embodiment, the specific name or title for the audience added to a campaign is associated to the visitor 3010 at the storage device 3040. In other embodiments, step 7044 is not necessary, such as where the DAS does not use “segments” to isolate an ad unit to a particular person or application used by that person to access a web-based information resource.

In one embodiment, the retargeting segment, “segment_bucket_1” contains multiple browsers. The Retargeting System 1030 may be configured to display the PCA Ad Unit to that retargeting segment only, retrieving the ad unit (e.g., content) for display to a given browser by (i) reading a cookie, fingerprint, or device ID on the browser and (ii) querying a storage device for a matching cookie, fingerprint, or device ID.

In another embodiment, the PCA System 1020 may add a cookie to place a browser in retargeting segment, “segment_bucket_1” that is associated to a campaign with aggressive bid and budget settings to communicate an ad unit to said browser on a WBIR that supports advertising. The PCA System 1020 may add a new cookie associated with segment, “long_term_bucket” to the browser, where another campaign associated to the “long_term_bucket” segment is configured with low bidding and budget settings as a means to maintain a messaging conduit to a browser. Occasionally, the PCA System 1020 causes an ad unit to be displayed to the browser via the “long_term_bucket” segment, and the PCA System 1020 adds a new cookie, “segment_bucket_2” that has aggressive bidding and budget settings as a means to communicate an ad unit to the browser. In this way, a browser may be selectively moved to and from segments, preserving the ability to communicate to the browser at a cost that is lower than maintaining said browser in “segment_bucket_1”.

Step 7045 causes the DAS 3050 to add one or more ad units to a campaign. For instance, the DAS 3050 may receive API commands from a PCA System 3030 to create a DAS ad unit based on a landing page URL and image ad unit 3300. Many other embodiments are possible, such as where the PCA System 3030 transmits API commands to a DAS 3050 to create a DAS ad unit based on a landing page URL and a Rich Media Unit, streaming video, or Flash ad unit 3300.

Step 7046 causes the DAS 3050 to set a campaign state. For example, where a campaign requires approval before the campaign is “active” (e.g., eligible to bid on impressions and display a DAS ad unit at websites that supports advertising), the DAS 3050 may receive API commands from a PCA System 3030 to submit a campaign for approval. In other embodiments, where such approval is unnecessary, the DAS 3050 may receive API commands from a PCA System 3030 to set the campaign status as active.

Similarly, step 7047 causes the DAS 3050 to set a DAS ad unit state. For example, where a DAS ad unit requires approval before it can be “active” (e.g., available to be added to a campaign or displayed at websites that supports advertising), the DAS 3050 may receive API commands from a PCA System 3030 to submit a DAS ad unit for approval. In other embodiments, where such approval is unnecessary, the DAS 3050 may receive API commands from a PCA System 3030 to set the DAS ad unit status as active.

Referring now to FIG. 7b, the PCA System 3030 may create a plurality of ad units 3300 from input 3200. Optionally, in step 7031, the PCA System 3030 may format and/or transform the input 3200 to fit within the pixel limits of the ad unit in a pleasing way. Optionally, step 7032 parses input 3200, looking for elements in the input 3200 that may specify additional text and/or graphics that will be included in the ad unit 3300 in addition to the input 3200—such as a logo or background color. In step 7033, the PCA System 3030 may add additional text and/or graphics beyond the input 3200, such as a logo or background color. Step 7034 reviews the input 3200 for a URL that identifies the landing page (e.g., href) when an ad unit 3300 is clicked. In one embodiment, step 7034 takes a naked URL from input 3200, and in other embodiments, step 7034 parses the input 3200 for an encoded URL. Step 7030 creates one or more ad units 3300 that combines transformed input, additional text, graphics, HTML and/or supplied landing page URL.

Method for Causing Advertising Units to be Displayed

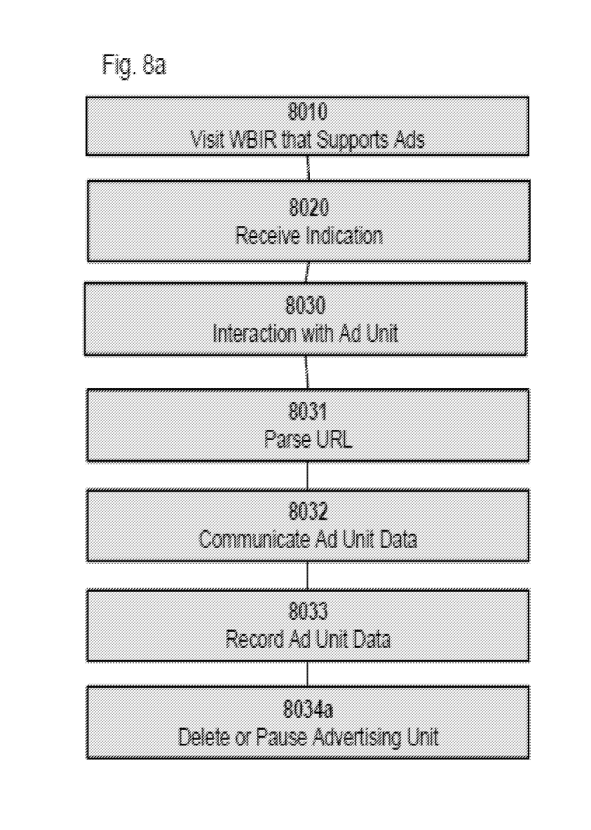

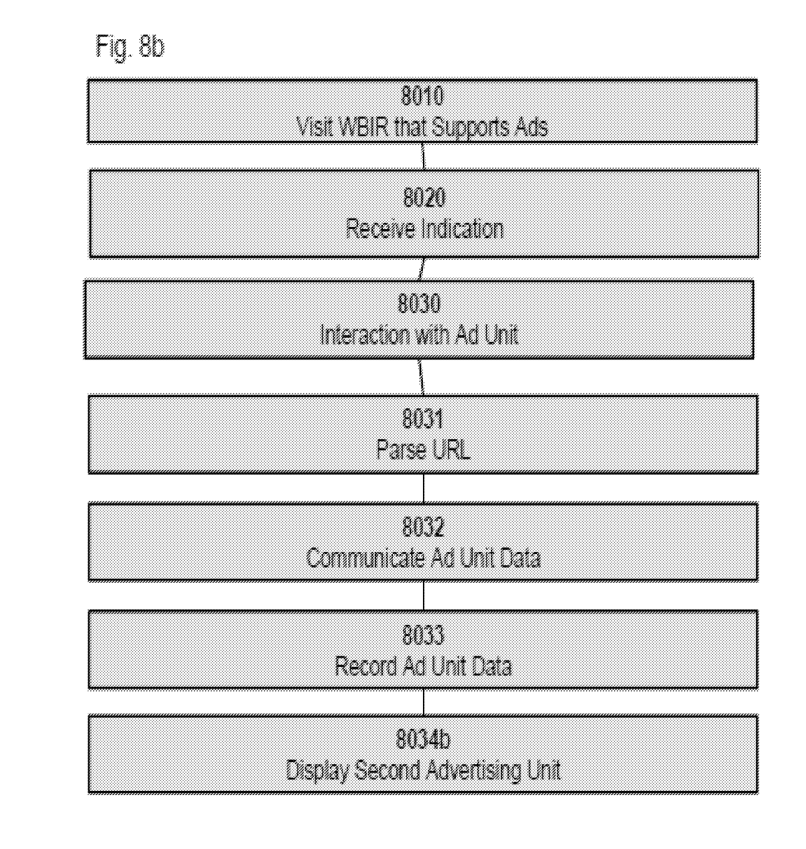

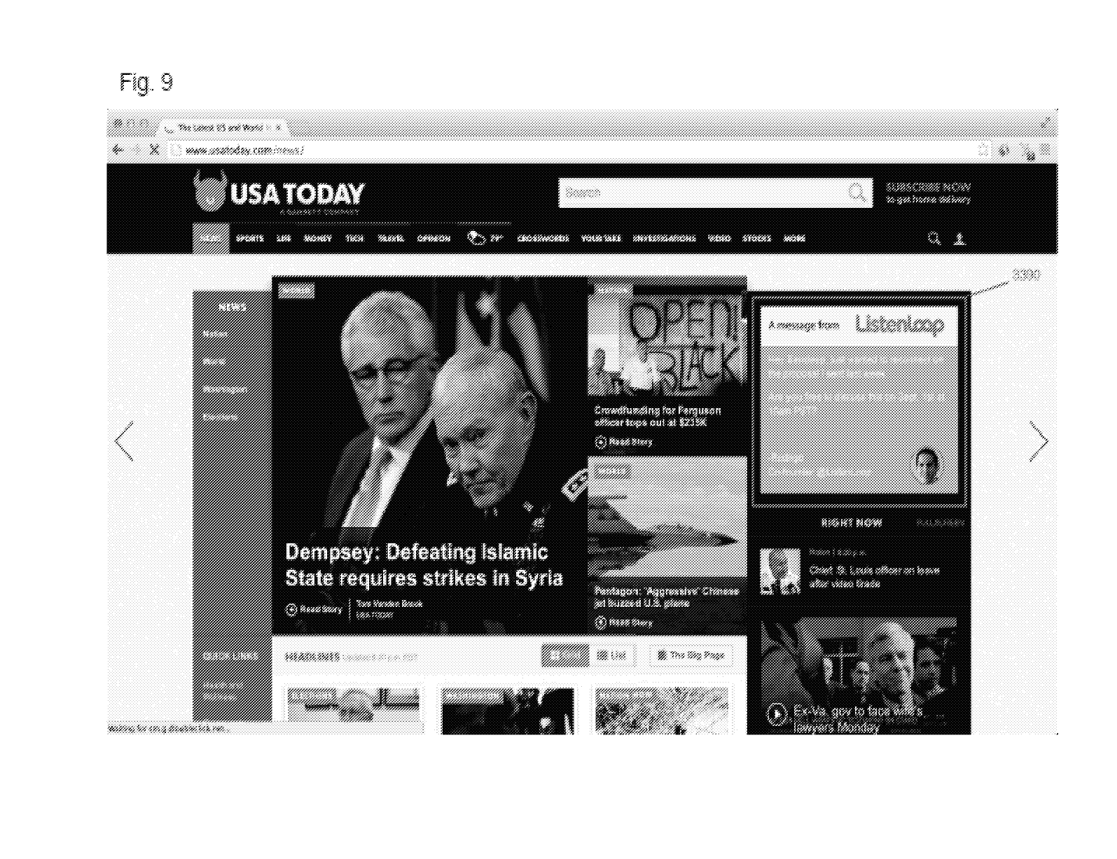

Turning now to FIG. 8, in step 8010, a visitor 3010 visits a web-based information resource that supports advertising 3210. For example, a person using a web browser 3010 navigates to www.USAToday.com that supports digital advertising in certain areas of its website (see FIG. 9).

Step 8020 receives an indication that the person 3010 is visiting one of the web-based information resources that support advertising. In one embodiment, a visitor 3010 navigates their web browser to the website USAToday.com 3210. That website may execute code that reads a DAS cookie if one is available on the visitor's web browser 3010. The website 3210 transmits the DAS cookie (or an identifier of the DAS cookie, such as a MD5 hash of its content) to an ad exchange. The ad exchange may communicate the DAS cookie (or an identifier of the DAS cookie) to one or more demand side platforms (“DSP”). Indications are provided if the DAS cookie (or its identifier) matches, or not, a record in a DSP. If there is an indication that there is a match, the demand side platform may programmatically bid on an impression for that particular visitor 3010. If there is an indication that there is no match, the demand side platform may forego bidding on the impression for that particular visitor 3010. In the absence of an indication that there is a match, the DSP may forego bidding on the impression for that particular visitor 3010. If DSP 3050 bids and wins the auction for the impression, then a DAS ad unit associated to the visitor 3010 may be displayed at USAToday.com.

Many other embodiments of step 8020 are possible. For example, an indication that the person 3010 is visiting one of the web-based information resources that support advertising may accomplished without a demand side platform, such as where a DAS 3050 communicates directly with a web-based information resource that supports advertising.

In step 8030, a visitor 3010 interacts—such as by clicking—with an ad unit displayed at the web-based information resource. Such interaction may navigate the visitor 3010 to a landing page, or such interaction may play an audio or visual message to the visitor 3010 at the web-based information resource that supports advertising.

In one embodiment, the method described herein causes the advertising unit not to be displayed at one or more webpages or websites that support advertising, in response to an indication that certain criteria have been met.

For example, in response to visitor 3010 interaction with a displayed ad unit, step 8030 may navigate the visitor 3010 to a target destination (e.g., a web-based information resource 3020) and append additional parameters to the target destination identifier (e.g., URL parameters for a landing page URL). In some embodiments, step 8030 may navigate the visitor 3010 to a landing page URL that already includes certain parameters supplied by the PCA System 3030.

In other embodiments, step 8030 may navigate the visitor 3010 to an intermediary web-based information resource associated with the PCA System 3030, such that a visitor's 3010 interaction may be recorded and the visitor 3010 is redirected to the landing page URL. This embodiment may be beneficial to record a visitor's interaction even where the landing page URL may not contain additional parameters or such parameters are removed.

In one embodiment, where the target destination is the website 3020, step 8031 parses the URL parameters to access information, such as the campaign name, segment name, visitor ID from whence the ad unit referrer came (the “advertising unit data”). There, step 8031 may be accomplished via the PCA JS file at the website 3020.

Step 8032 communicates the advertising unit data to the PCA System 3030. This may be accomplished via an API, JavaScript, or other means for communicating between a web-based information resource and a web server.

Step 8033 records the advertising unit data in a storage device 3040. In one embodiment, the PCA System 3030 communicates the advertising unit data to a PostgreSQL database, associating the visitor 3010 interaction to that visitor's existing “visitor_id” and/or fingerprint.

In one embodiment, step 8034a causes the DAS 3050 to create, read, update, or delete the campaign, audience, and/or ad units associated to the visitor 3010, which may be in response to an indication that certain criteria have been met. In another embodiment, step 8034b causes the DAS 3050 to display a second advertising unit to the visitor 3010, which may be in response to an indication that certain criteria have been met. The DAS 3050 may receive API commands from a PCA System 3030 to accomplish steps 8034a, b.

With respect to step 8034a,b, a campaign, audience, and/or ad unit may be paused, updated, or deleted if one or more of the following criteria are met:
the ad unit was displayed to the visitor 3010 N-times;
the visitor 3010 interacted with a displayed ad unit N-times;
the visitor 3010 navigated to the website 3020 and took an action, such as submitting an online form for a demo request;
the visitor 3010 has not interacted with a displayed ad unit in N-days; and/or
the agent associated to the website 3020 indicates that the ad unit should not be displayed;
the visitor's 3010 data corresponding to its CRM record reflected a particular value, such as “Lead Status=MQL.”

Many other criteria are possible, and the foregoing list provides a few non-limiting examples.

Criteria, like that much above, may be used to cause a second advertising unit to display at a web-based information resource that supports advertising. In this way, “workflows” or “advertising drip campaigns” may be created so that an agent 3110 can create a sequence of input 3200 for display to a visitor 3010.

Handling Repeat Visits

There are many ways to handle repeat visits to a website 3020, such that an agent's message is specifically targeted to a particular person or an application that the person used to access the web-based information resource—and no one else.

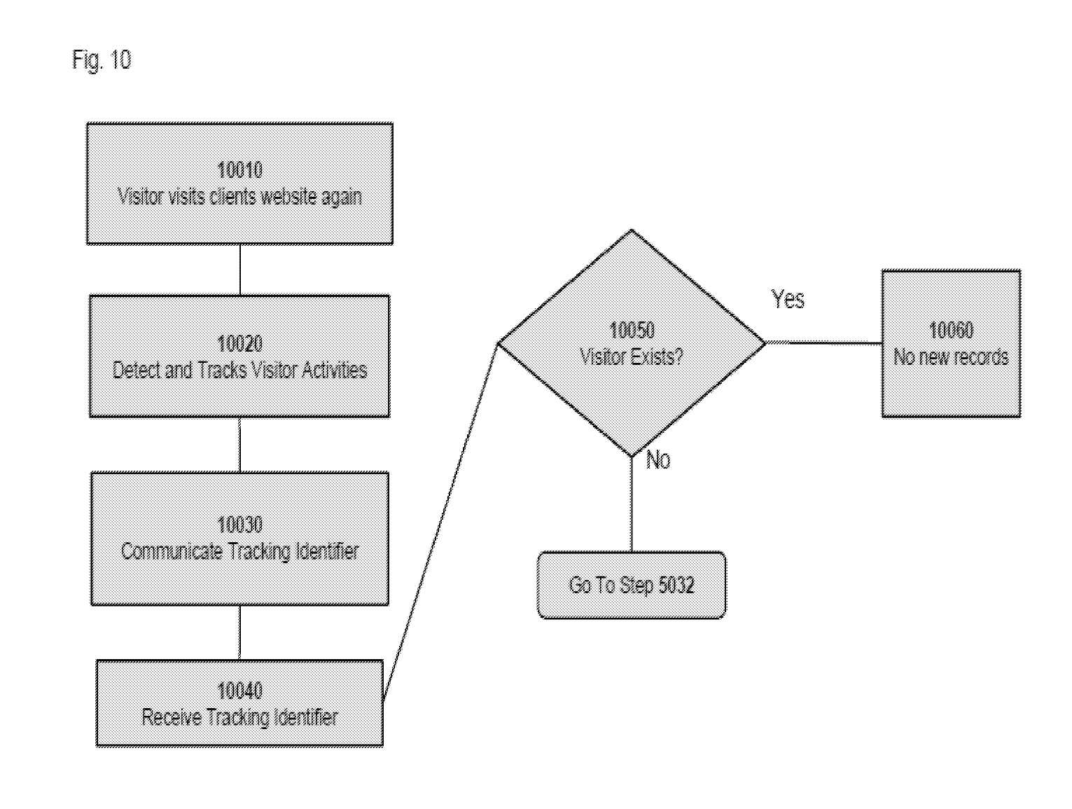

Turning now to FIG. 10, in step 10010 a browser 3010 visits a web-based information resource 3020 more than once. For instance, a person navigates their browser 3010 to the website www.FreelanceFinder.com 3020 on Sep. 16, 2014 for the first time (the “first visit”) and then again on Oct. 14, 2014 (the “next visit”).

Step 10020 generates and communicates the visitor's 3010 fingerprint to the PCA System 3030. In another embodiment, step 10020 may access a PCA cookie if one is available from the visitor 3010. Step 10030 communicates the PCA cookie, its contents, or some identifier for the PCA cookie (e.g., a MD5 hash) to the PCA System 3030. Step 10030 may also communicate the visitor 3010 activities to the PCA System 3030.

Step 10040 receives tracking identifiers for the visitor 3010, such as the fingerprint, the PCA cookie, or the fingerprint and the PCA cookie. Step 10050 queries a storage device 3040 to determine if the tracking identifiers exist at the storage device 3040. For instance, the PCA System 3030 may communicate the browser 3010 fingerprint to a PostgreSQL database 3040.

In step 10060, the storage device may not create a new record or new audience name if the fingerprint or PCA cookie already exists in the storage device. In this way, the PCA System 3030 may maintain a 1-to-1 relationship between (i) a person or an application that the person used to access the web-based information resource 3010 and (ii) an agent's message 3200 to that person or application that the person used to access the web-based information resource 3010. In other embodiments, the PCA System 3030 may maintain a 1-to-many relationship between (i) an agent's message 3200 to that person or application that the person used to access the web-based information resource 3010 and (ii) multiple devices or application that the person used to access the web-based information resource 3010.

Handling Multiple Agent Communications

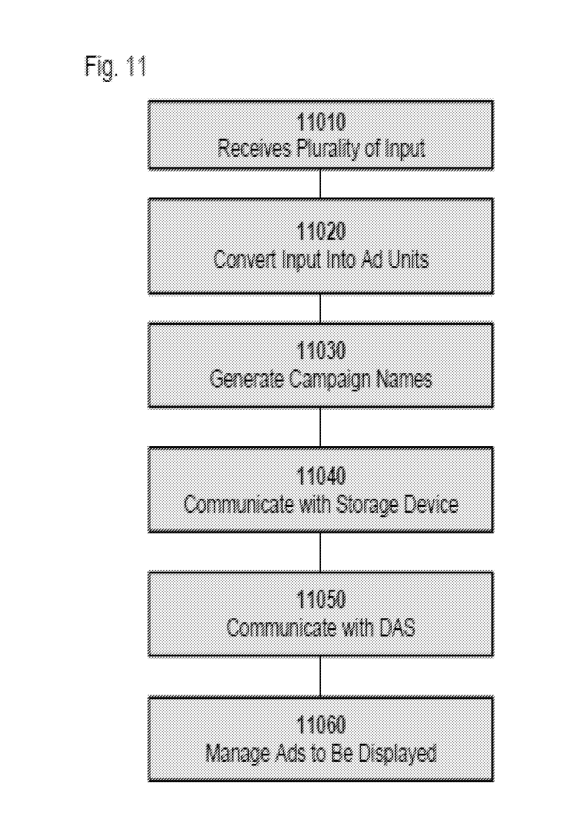

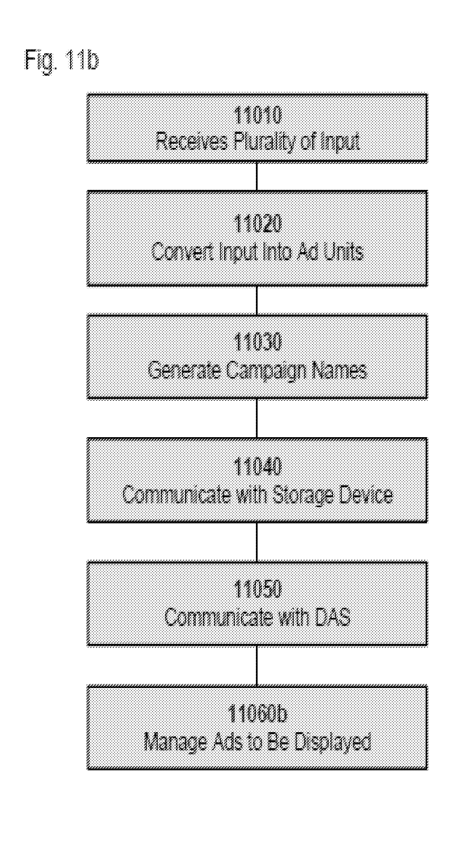

Turning now to FIG. 11, the PCA System 3030 may receive a plurality of instructions from an agent associated with the web-based information resource 3110 to communicate with the person 3010 whose activities have been tracked. For example, an agent 3110 may provide a plurality of input 3200 to a PCA System 3030. The agent 3110 may input a first message 3201, such as “Hi ACME Co., thanks for visiting our blog at FreelanceFinder.com. Click here to download our eBook.” A few days later, the agent 3110 inputs a second message 3202, “Hey ACME Co., just wanted to check-in. Would you like a demo of our software?”

Many embodiments are possible to handle such circumstances, including but not limited to:
(i) causing a first advertising unit based on the first message to stop displaying at a web-based information resource that supports advertising and causing a second advertising unit based on the second message to be displayed at a web-based information resource that supports advertising;
(ii) causing a plurality of advertising units based on a plurality of messages to be displayed simultaneously at a web-based information resource that supports advertising; or
(iii) causing a plurality of advertising units based on a plurality of messages to be displayed in a particular sequence at a web-based information resource that supports advertising based on meeting certain criteria.

In one embodiment, step 11010 receives a first message 3201 and a second message 3202 at the PCA System 3030. Each input 3201, 3202 may include identifier information for a visitor 3010, such as an audience name, visitor ID, fingerprint, and/or PCA cookie.

Step 11020 converts the plurality of inputs 3201, 3202 into a plurality of ad units 3301, 3302. Step 11030 generates new campaign names (e.g., “first campaign” and “second campaign” corresponding to the first message and second message). Step 11040 communicates with a storage device 3040 to modify, create, and/or associate campaign names and input 3201, 3202 to a visitor 3010. Step 11050 may communicate the campaigns, ad units 3301, 3302, and audience name to a DAS 3050.

In one embodiment, step 11060 may create, read, update, or delete the first campaign and activate the second campaign, such that a first advertising unit based on the first message may not display at a web-based information resource that supports advertising while a second advertising unit based on the second message may be displayed at a web-based information resource that supports advertising.

In another embodiment, step 11060 may delete the first ad unit 3301, such that a first advertising unit based on the first message 3301 may not display at a web-based information resource that supports advertising 3210 while a second advertising unit based on the second message 3302 may be displayed at a web-based information resource that supports advertising 3210.

In another embodiment, step 11060 does not need to create, read, update, or delete ad units to selectively display the first message 3301 or second message 3302. Here, the appropriate content—such as HTML5—is retrieved from a database using a cookie, fingerprint, or other identifier to be displayed to a given browser.

In some embodiments, step 11060 does not delete, update, or pause the first campaign, such that a first advertising unit based on the first message 3301 may be displayed at a web-based information resource that supports advertising 3210 while a second advertising unit based on the second message 3302 may be displayed at a web-based information resource that supports advertising 3210. Here, the first and second advertising units 3301, 3302 may be displayed simultaneously at a web-based information resource that supports advertising.

In other embodiments, step 11060 causes the deletion, pausing, updating, or activation of the first or second campaign at the DAS 3050 based on certain criteria (see, e.g., step 8034a,b for exemplary criteria), such that a plurality of advertising units based on a plurality of messages to be displayed in a particular sequence at a web-based information resource that supports advertising.

Turning to FIG. 11b, in some embodiments, a visitor 3010 may visit a plurality of websites 3021, 3022 that are coupled to a PCA System 3030. The PCA System 3030 may coordinate the deletion, pausing, updating, or activation of the first or second campaign at the DSP 3050 based on certain criteria (see exemplary criteria below), such that a plurality of advertising units based on a plurality of messages from different agents 3150, 3160 from different websites 3021, 3022 are displayed simultaneously or in a particular sequence to a visitor 3010 at a web-based information resource that supports advertising 4300.

Step 11010 receives a plurality of input from different agents 3150, 3160 who are associated to different websites 3021, 3022. Step 11020 converts the plurality of input into a first ad unit based on the first input 3251 and a second ad unit based on the second input 3252. Step 11030 generates corresponding campaigns names for the first and second ad units. Step 11040 communicates with a storage device 3040 to store or modify the campaign names, inputs, ad units, or other information. Step 11050 may communicate the campaigns, ad units, audience name, and other information, to a DAS 3050.

Step 11060b may cause the first ad unit based on first input 3251 to be displayed, rather than the second ad unit based on the second input 3252 to be displayed, if one or more of the following criteria are met:
the first ad unit was created before the second ad unit;
the first ad unit has a higher cost per mile (CPM) bid amount than the second ad unit;
the second ad unit has exhausted its frequency cap;
the second ad unit may not be displayed at the time the visitor navigated to the website that supports advertising;
the second ad unit may not be displayed at the geographical location for the visitor 3010; and
the second ad unit is not eligible to be displayed at the website that supports advertising.

In another embodiment, step 11060b may instruct the DAS 3050 to use its own logic to control whether the first or second ad unit should be displayed.

Tracking Visitors

There are many ways to track visitors 3010 as described in the methods and systems described herein. In one embodiment, a system or method may use two tracking identifiers to track visitors by a PCA System 3030 and a DAS 3050.

For instance, a first tracking identifier (such as a DAS cookie) may help cause or disable a WBIR that supports advertising, such as CNN.com, to show an advertising unit. A second tracking identifier, such as a PCA cookie, may help identify which campaign and/or ad unit should be displayed to a visitor as identified by the PCA cookie.

In another embodiment, a first tracking identifier (such as a DAS cookie) may help cause or disable a WBIR that supports advertising, such as CNN.com, to show an advertising unit. A second tracking identifier, such as a fingerprint, may help identify which campaign and/or ad unit should be displayed to a visitor as identified by the fingerprint.

In another embodiment, a PCA System 3030 may track a visitor by transmitting a PCA cookie to the visitor 3010, where the PCA cookie is setup in such a way that any subdomain can read the PCA cookie. A DAS 3050 may be configured to show a specific ad unit to a visitor 3010 who has the PCA cookie—without requiring a DAS cookie. For instance, the PCA System may be configured such that a CNAME record points to a subdomain to a DAS application, allowing that DAS the ability to read PCA cookies.

Narrative Description of Sample Use Case

FIGS. 12-20 provide one embodiment of the present invention in a narrative as viewed from the computer display of a visitor 3010 and a computer display of an agent 3110.

Turning to FIG. 12, Sandeep is the director of Product Management at Box.com. He's a highly valuable sales prospect for ListenLoop, a B2B software company that targets product managers.

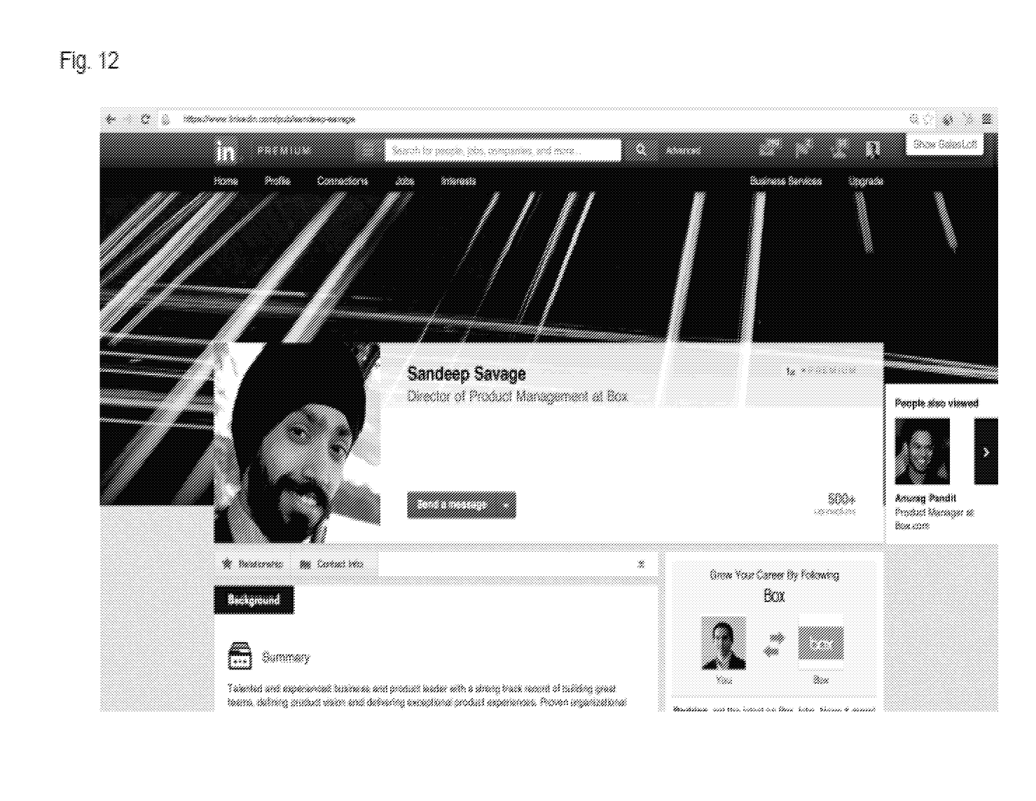

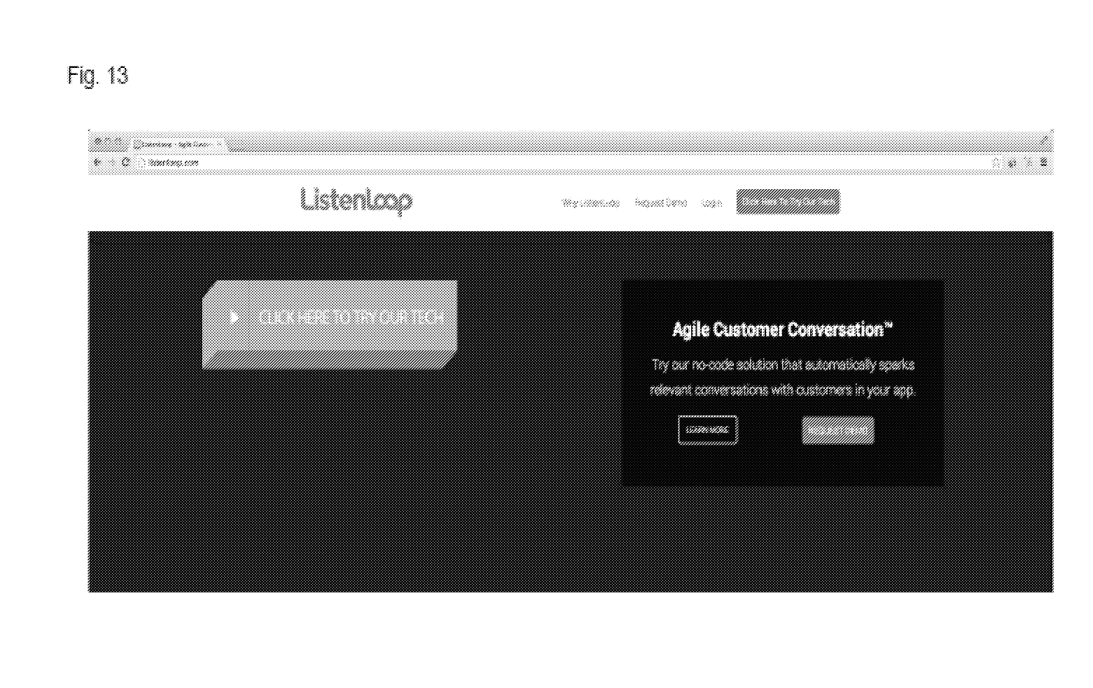

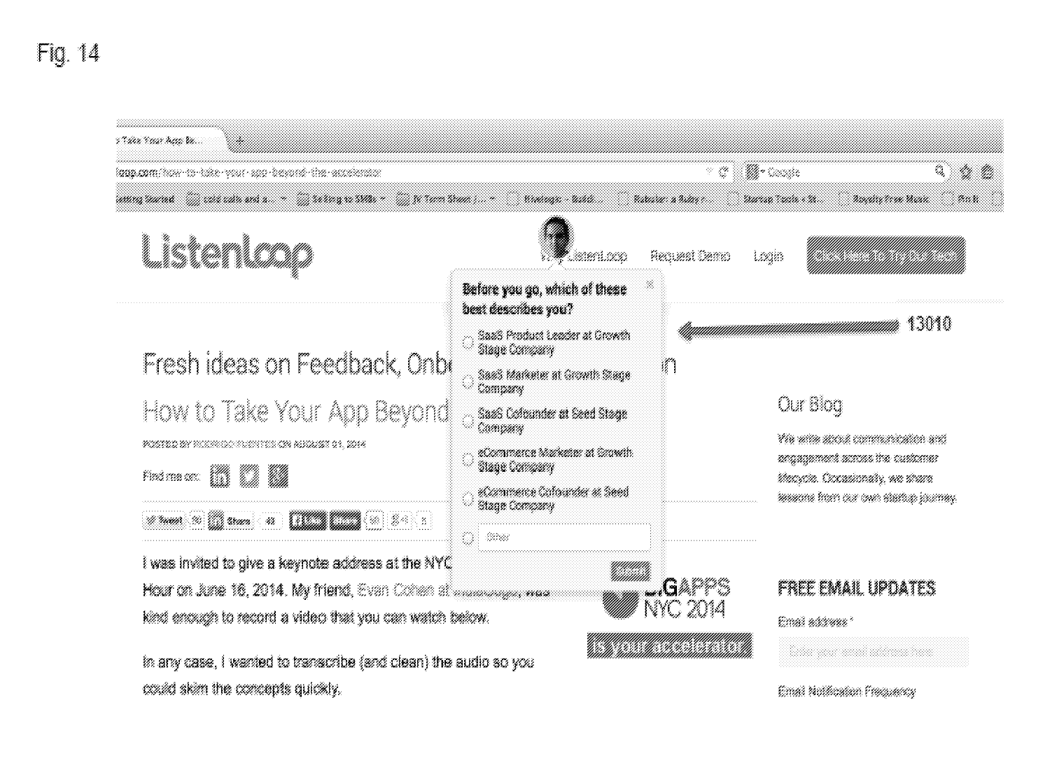

Sandeep recently heard about ListenLoop, and he navigates his browser 3010 to the website, listenloop.com 3020. FIG. 13 depicts what Sandeep 3010 see when the browser interacts with the website 3020. Sandeep 3010 browses around and interacts with the website 3020. Sandeep 3010 provides his first name and answers a few questions 13010, as depicted in FIG. 14. Then he clicks on the “About Us” page. After a few seconds of reading, Sandeep clicks on the “Demo Request” link, but he exits before filling out the online form. Such visitor activities are recorded by a PCA System 3030 coupled to the website 3020.

Such visitor activities—browsing but not completing a demo request—accounts for at least 90% of traffic to ListenLoop.com, representing a large number of missed sales opportunities.

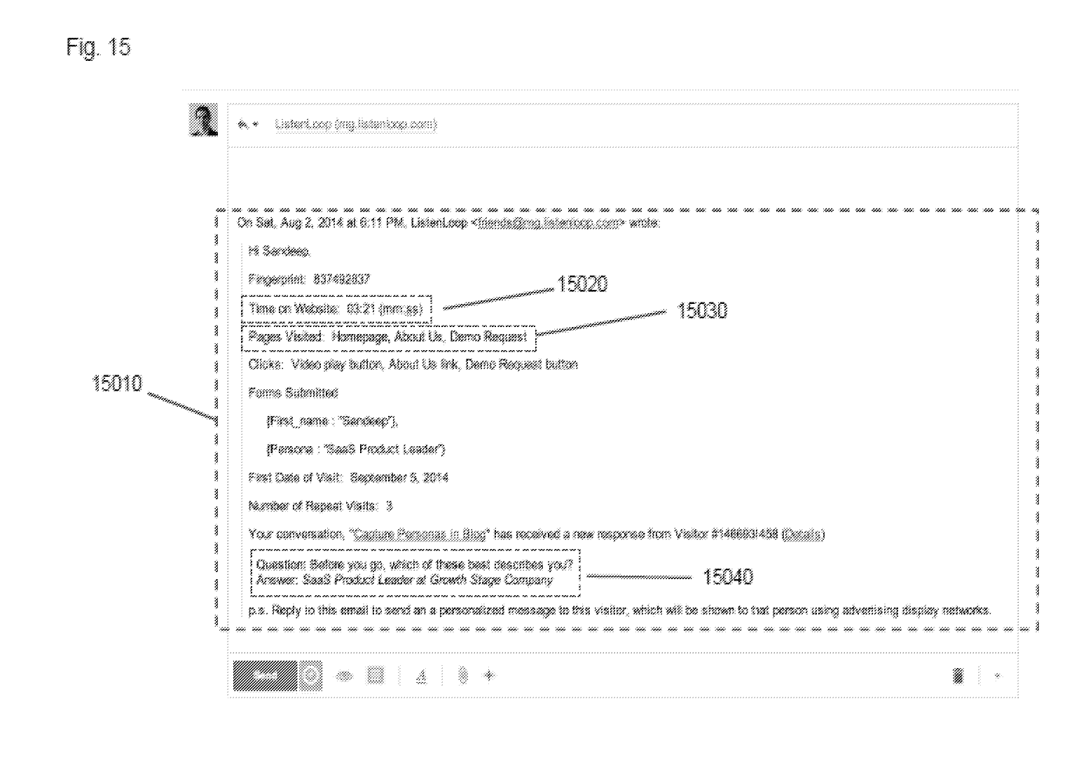

After Sandeep 3010 leaves the ListenLoop website 3020, the PCA System 3030 emails a report to Rodrigo, an agent 3110 associated to ListenLoop.com 3020. FIG. 15 illustrates a sample email report 15010 that Rodrigo may receive through his email application, Gmail. The report may identify Sandeep's time on site 15020, pages visited 15030, and submitted responses 15040, among other things.

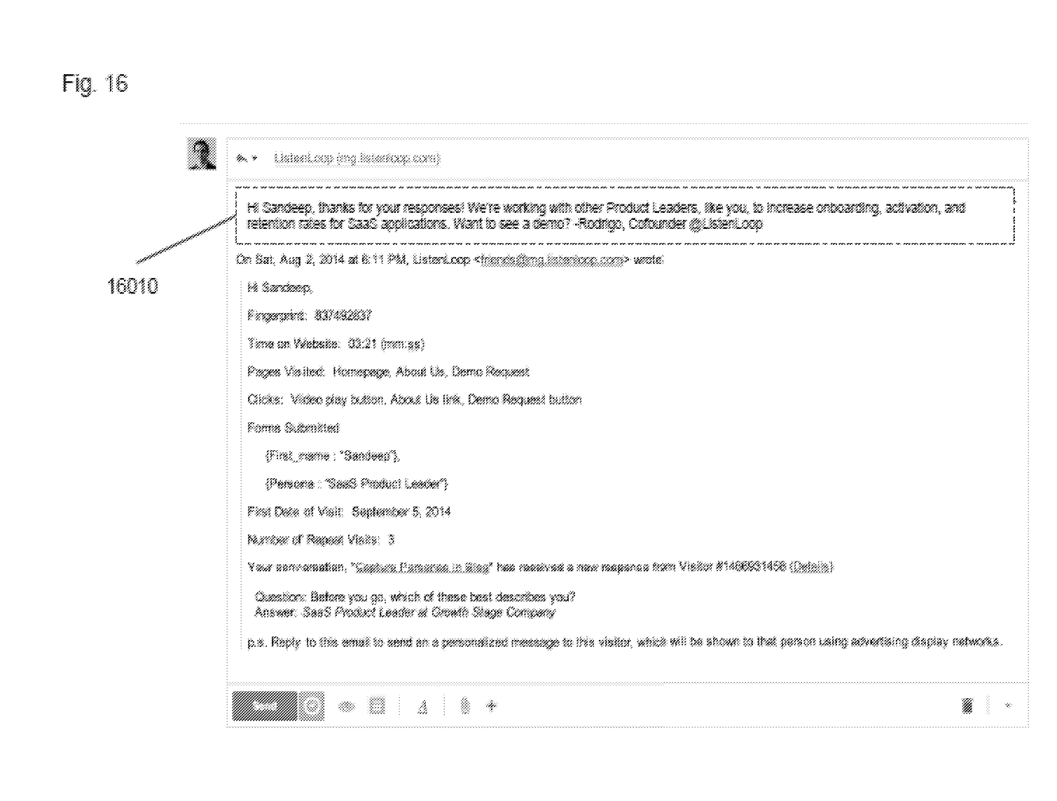

Based on the information in the report, Rodrigo 3110 believes that this person is a good prospect and drafts a reply message 3201 to the email, as depicted in FIG. 16:
“Hi Sandeep, thanks for your responses! We're working with other Product Leaders, like you, to increase onboarding, activation, and retention rates for SaaS applications.
Want to see a demo?
-Rodrigo, Cofounder @ListenLoop” 16010

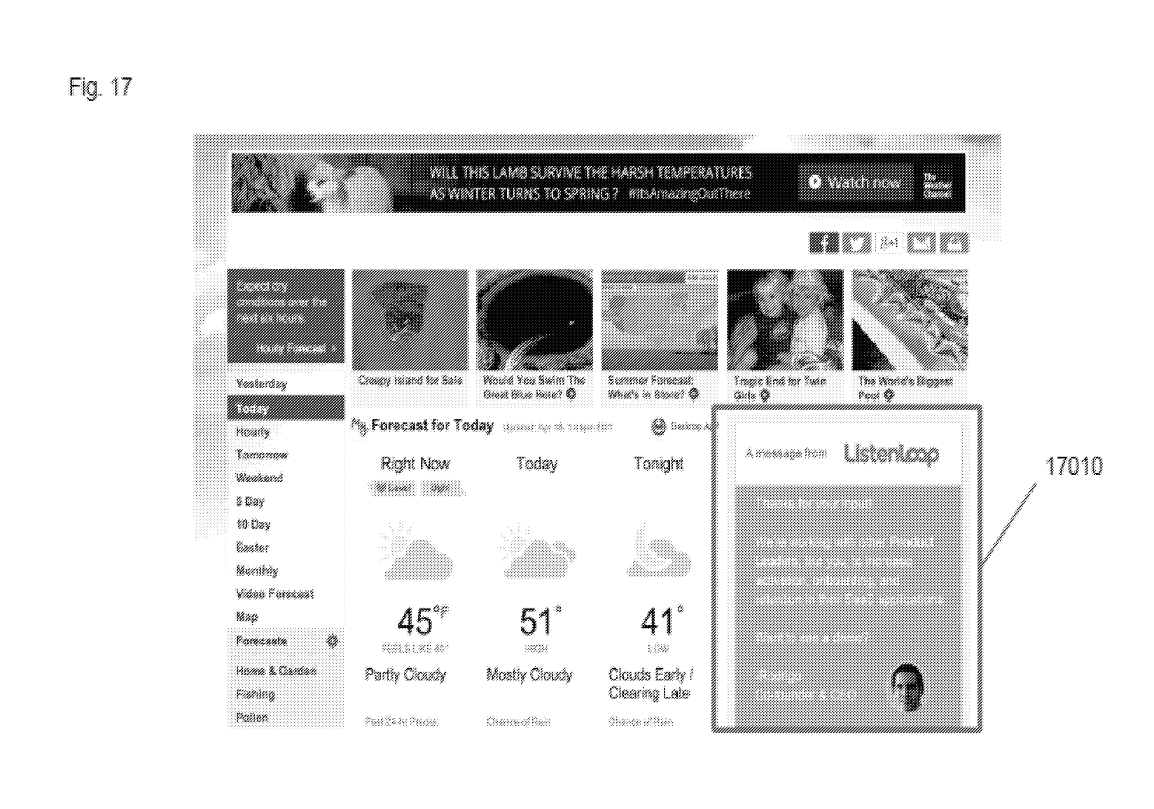

A day after visiting ListenLoop.com 3020, Sandeep 3010 visits Weather.com 3210. FIG. 17 depicts what Sandeep 3010 may view at Weather.com, including an advertising unit 17010 that includes Rodrigo's 3110 message 3201 to Sandeep 3010.

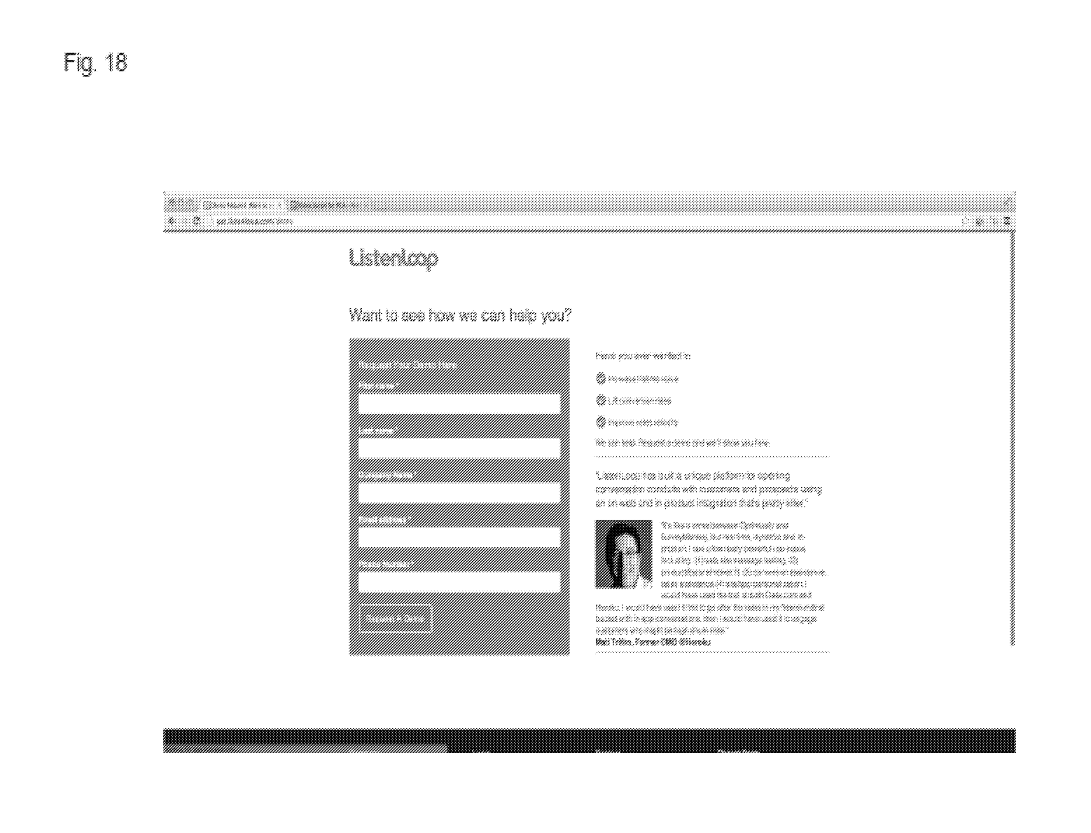

Sandeep 3010 clicks on the advertising unit 17010 and lands on a demo request page as illustrated in FIG. 18. Sandeep 3010 fills out the form, takes a demo, and receives a sales proposal.

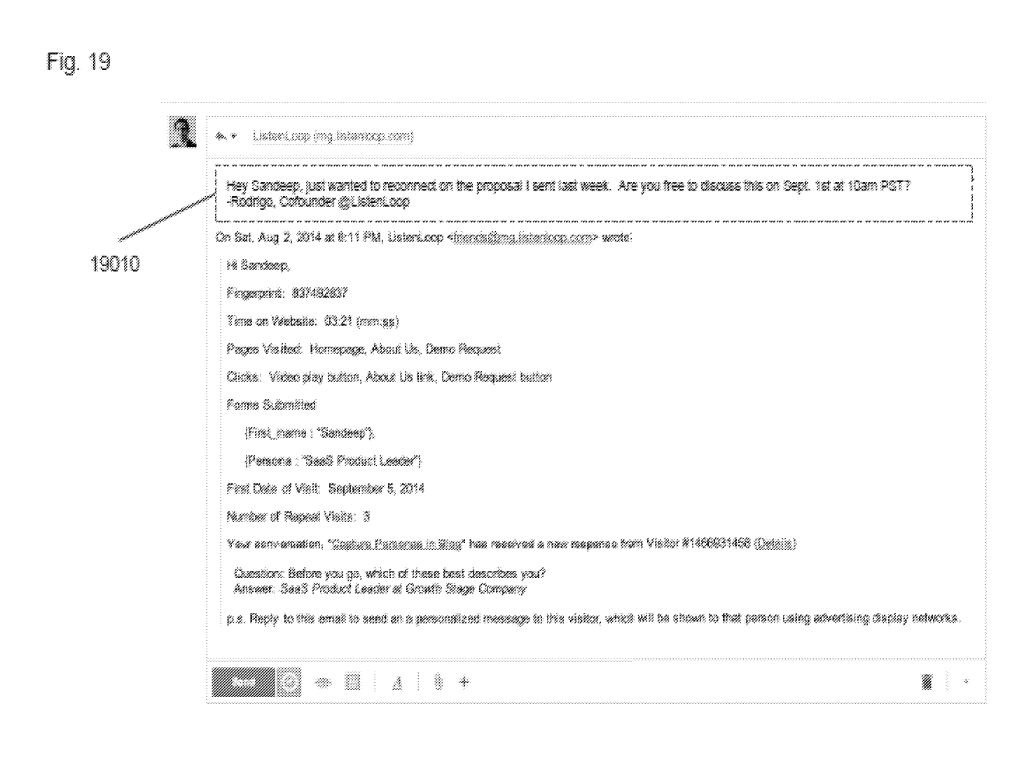

But Sandeep 3010 got busy with other projects and forgets the sales proposal. Rodrigo 3110 tried calling and emailing Sandeep to no avail. Rodrigo 3110 drafts another message 3202 by sending another reply to the email report, as depicted in FIG. 19:
“Hey Sandeep, just wanted to reconnect on the proposal I sent last week. Are you free to discuss this on September 1st at 10 am PST?
-Rodrigo, Cofounder @ListenLoop” 19010

Referring now to FIG. 20, Sandeep 3010 may see a second advertising unit 20010 based on a second message 3202 when he visits USAToday.com 3210. Sandeep 3010 clicks on the advertising unit 20010, taking him to a scheduling page to confirm the date and time for his follow-up call with Rodrigo 3110.

### Other Sample Use Cases

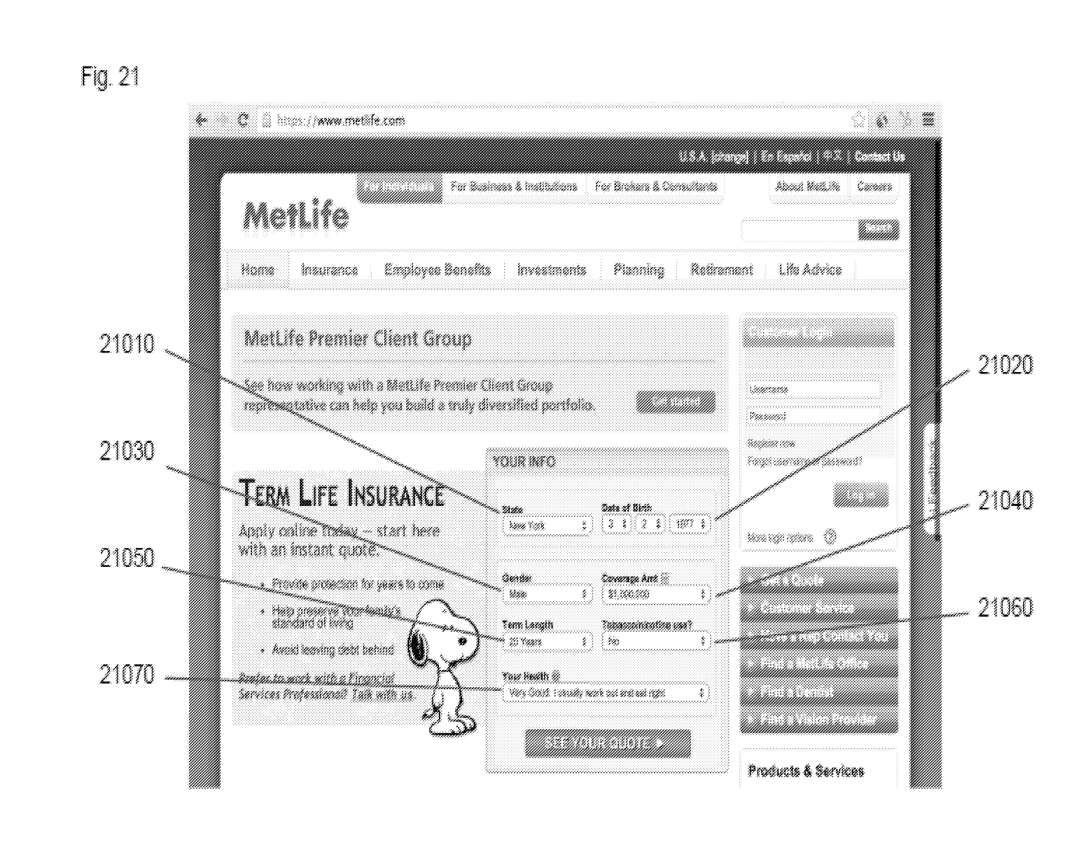

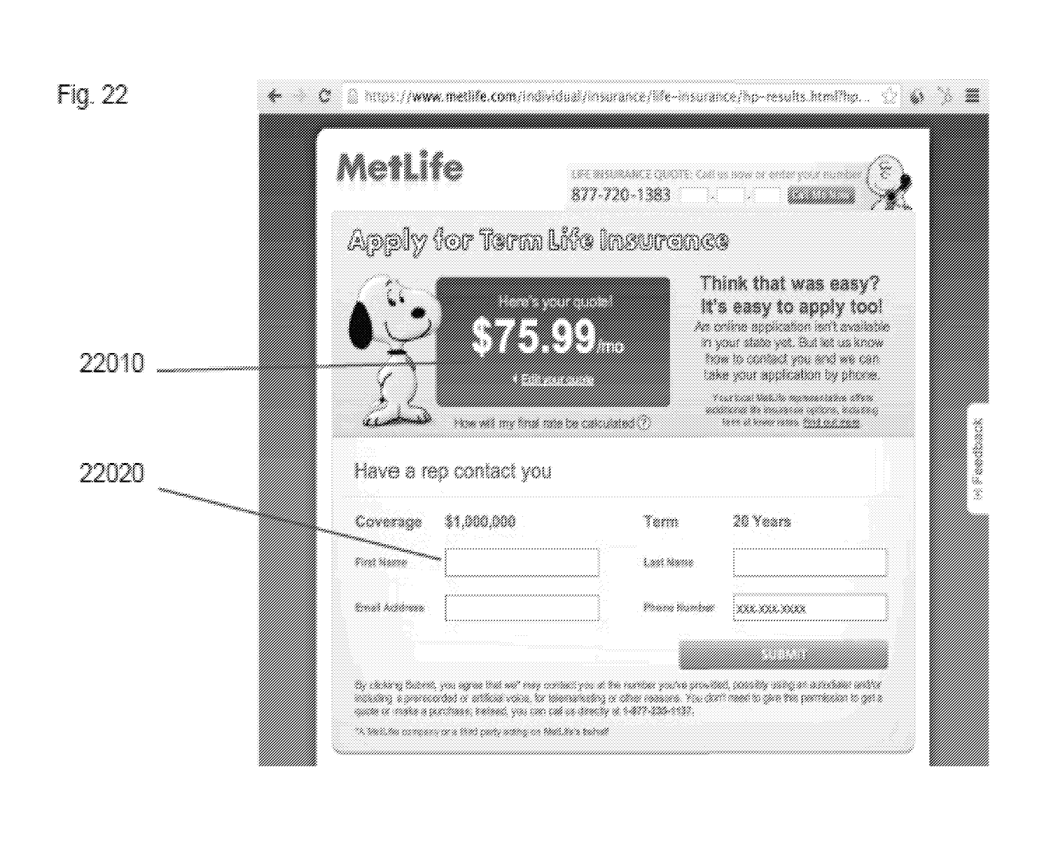

Many other use cases are possible. Assume a visitor 3010 visits a life insurance website 3020, such as metlife.com as depicted in FIG. 21. The visitor 3010 submits an online form, providing their state of residence 21010, birthday 21020, gender 21030, coverage desired 21040, desired term length 21050, whether they use nicotine 21060, and their state of health 21070. Submitting the form takes the visitor to the next page, illustrated in FIG. 22, which depicts a quote amount 22010 and other form fields, including a first name 22020.

An agent for Metlife.com 3110 may receive a report via and prepare the following instructions 3200:
Hi there, we quoted you $75.99 per month for 20 year term life insurance. Are you still interested?
Term life insurance can be intimidating. Let's schedule a call so we can discuss your options and answer any questions you may have.
Click here to schedule a call.
-Isabella
Your MetLife Advocate

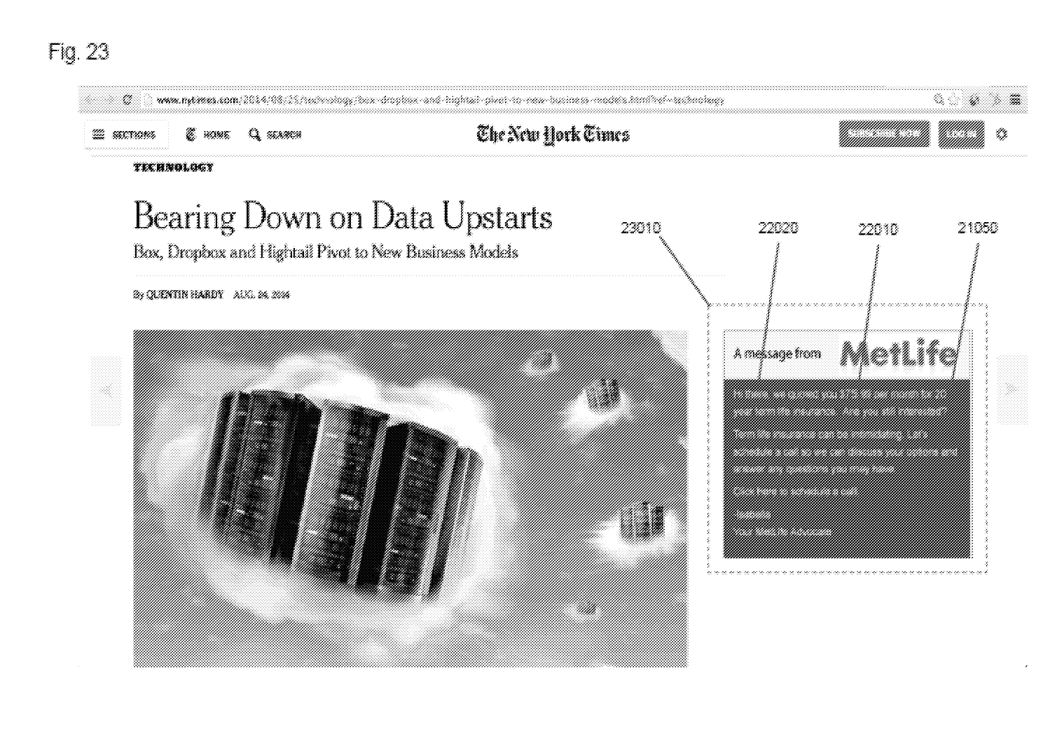

Turning now to FIG. 23, after visiting MetLife.com 3020, the visitor 3010 navigates to NYTimes.com 3210, which may display an advertising unit 23010 that includes the agent's 3110 message 3200 to that visitor 3010.

In another embodiment, the PCA System 3030 may receive online form submissions or other submitted data as input 3200, such that the PCA System 3030 can automatically create one or more ad units using a template, such as:
Hi {IF:NAME 22020, “there”}, we quoted you {QUOTE 22010} per month for {PRODUCT 21050} insurance. Are you still interested?
Term life insurance can be intimidating. Let's schedule a call so we can discuss your options and answer any questions you may have.
Click here to schedule a call.
-John Doe,
Your MetLife Advocate

In this embodiment, each visitor 3010 who submitted responses may receive a highly personalized ad unit based on their activities at the website 3020 with little or no effort by the agent 3110.

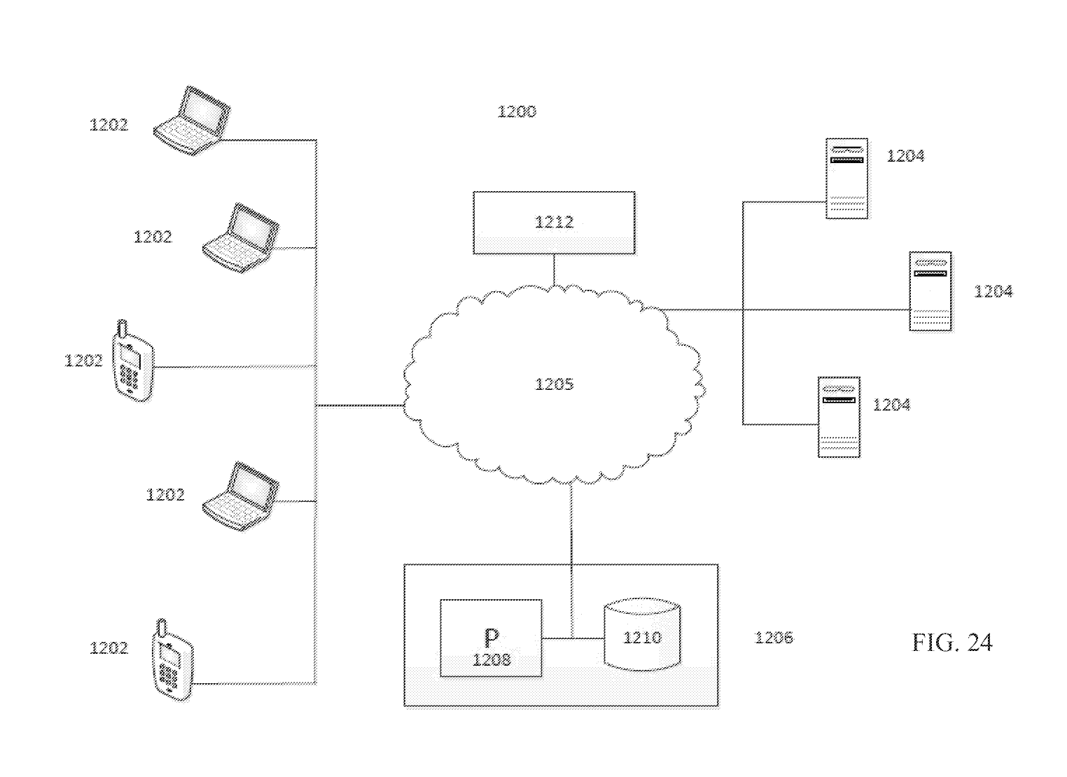

FIG. 24 shows an exemplary implementation of a system to facilitate/implement one or more of the techniques disclosed herein. More particularly, FIG. 24 shows an exemplary computer-based system 1200 to facilitate communicating with a visitor to a web-based information resource.

The illustrated computer-based system 1200 includes one or more computers 1202, each of which has an application that facilitates accessing one or more web-based information resources (e.g., websites, webpages, mobile applications, etc.). The illustrated computer-based system 1200 also has multiple computer servers 1204, each of which is configured to host one or more of the web-based information resources. In a typical implementation, at least some of the web-based information resources support advertising. The computer servers 1204 are coupled to the computers 1202 via a computer-based network 1205 (e.g., the Internet). The illustrated system 1200 also includes a computer-based processing system 1206 (e.g., one that may incorporate or supports PCA system functionality, as described herein). The computer-based processing system 1206, which may be a web server, includes a computer-based processor 1208, a computer-based memory device 1210 coupled to the computer-based processor 1208. The illustrated system 1200 also includes a demand side platform 1212.

In a typical implementation, the computer-based processor 1208 is configured to: track a person's activities while on one of the web-based information resources via one of the applications that facilitate accessing web-based information resources. Moreover, the computer-based processor 1208 is configured to receive instructions from an agent (e.g., at one of the computers 1202) associated with the accessed web-based information resource to communicate with the person whose activities have been tracked. The computer-based processor 1208 is configured to create an advertising unit with a communication to the person whose activities have been tracked based on the agent's instructions. The advertising unit is then caused to be displayed at one or more of the web-based information resources that support advertising, only in response to an indication that the person is visiting one of the web-based information resources that supports advertising.

In some implementations, tracking the person's activities on a web-based information resource include: assigning a fingerprint to the person or an application that the person used to access the web-based information resource and/or sending a cookie to the application that the person used to access the web-based information resource, creating a record that includes information about the person's activities on the web-based information resource; and associating the record with the fingerprint, the cookie or the fingerprint and the cookie.

In some implementations, the computer-based processing system 1206 is configured to present to the agent associated with the web-based information resource information related to the tracking of the person's activities on the web-based information resource and receive input from the agent in response to presenting the information. In a typical implementation, the input from the agent includes the agent's instructions to communicate with person.

The computer-based processing system 1206 is configured to convert at least part of (perhaps an entirety of) the agent's instructions to an advertising unit with a format that can be displayed as an advertisement on one or more of the web-based information resources that support advertising. The display would appear to the person under certain circumstances described herein at one of the computers 1202.

There are a number of ways in which the advertising unit is caused to be displayed at one of the web-based information resources that support advertising in response to an indication that the person is visiting one of the web-based information resources that supports advertising. In one example, the computer-based processing system requests that a demand side platform (e.g., a GetIntent system) create a segment having a particular designation, and installs code from the demand side platform into the application that the person used to access the web-based information resource. The code, in a typical implementation, is configured so that when it is run at the person's application it causes the demand side platform to add the person or the application the person is using to the segment.

In a typical implementation, the computer-based processing system 1206 and/or the overall system 1200 are configured to implement and/or support other aspects of functionality described herein.

A number of embodiments of the invention have been described. Nevertheless, it will be understood that various modifications may be made without departing from the spirit and scope of the invention.

For example, embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

Computer storage mediums (e.g., a non-transitory computer readable medium) can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” (e.g., a processor or the like) encompasses all kinds of apparatus, devices, and machines for processing data, including by way of example a programmable processor, a computer, a system on a chip, or multiple ones, or combinations, of the foregoing. Moreover, use of the term data processing apparatus should be construed to include multiple data processing apparatuses working together. Similarly, use of the term memory or memory device or the like should be construed to include multiple memory devices working together.

Computer programs (also known as programs, software, software applications, scripts, or codes) can be written in any form of programming language, including compiled or interpreted languages, declarative or procedural languages, and can be deployed in any form.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both.

A computer device adapted to implement or perform one or more of the functionalities described herein can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including, for example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented using a computer device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Other implementations are within the scope of the claims.

What is claimed is:

1. A computer-based method to facilitate communicating with a visitor to a web-based information resource, the method comprising:
tracking a person's activities on the web-based information resource;
receiving instructions from an agent associated with the web-based information resource to communicate with the person whose activities have been tracked;
creating an advertising unit with a communication to the person based on the agent's instructions; and
causing the advertising unit to be displayed at one or more web-based information resources that support advertising.

2. The computer-based method of claim 1, wherein causing the advertising unit to be displayed at the one or more web-based information resources that support advertising happens only in response to an indication that the person is visiting that one of the web-based information resources that supports advertising.

3. The computer-based method of claim 1, wherein the agent is a human who enters the instructions at a computer.

4. The computer-based method of claim 3, wherein the instructions are entered by the human after the person's activities have been tracked and in response to a prompt to the human at the computer.

5. The computer-based method of claim 3, wherein the instructions are entered by the human in advance of tracking the person's activities on the web-based information resource.

6. The computer-based method of claim 1, wherein the agent is a computer server configured to provide the instructions.

7. The computer-based method of claim 1, wherein the advertising unit is not displayed absent an indication that the person is visiting one of the web-based information resources that support advertising.

8. The computer-based method of claim 1, wherein tracking the person's activities comprises:
assigning a fingerprint to the person or an application that the person used to access the web-based information resource and/or sending a cookie to the application that the person used to access the web-based information resource;
creating a record that includes information about one or more of the person's activities on the web-based information resource or demographics; and
associating the record with the fingerprint, the cookie or the fingerprint and the cookie.

9. The computer-based method of claim 1, wherein receiving the agent's instructions to communicate with the person whose activities have been tracked comprises:
presenting to the agent information related to the tracking of the person's activities on the web-based information resource or demographics; and
receiving input from the agent in response to presenting the information, wherein the input from the agent comprises the agent's instructions to communicate with the person.

10. The computer-based method of claim 9, wherein presenting the information to the agent comprises presenting the information via email, text message, a web dashboard, a mobile application, or any other computer-based media that is able to facilitate presenting information.

11. The computer-based method of claim 1, wherein presenting the information to the agent occurs only if the tracked activities of the person at the web-based information resource satisfy one or more criteria.

12. The computer-based method of claim 1, wherein the agent's instructions include a message specifically targeted to the person and no one else.

13. The computer-based method of claim 12, wherein the advertising unit that appears at one of the web-based information resources that support advertising includes the message specifically targeted to the person and no one else.

14. The computer-based method of claim 1, wherein the agent's instructions identify a web address for a landing page that will appear if the person clicks on the advertising unit when it is displayed at one or more of the web-based information resources that support advertising.

15. The computer-based method of claim 1, wherein creating the advertising unit with the communication to the person based on the agent's instructions comprises:
converting at least part of the agent's instructions to a format that can be displayed as an advertisement on the one or more web-based information resources that support advertising.

16. The computer-based method of claim 1, wherein causing the advertising unit to be displayed comprises:
requesting that a demand side platform create a segment having a particular designation; and
executing code from the demand side platform into an application that the person used to access the web-based information resource, wherein the code is configured such that, when run at the person's application, the demand side platform adds the person or the person's application to the segment.

17. The computer-based method of claim 16, further comprising:
transmitting the advertising unit to the demand side platform for displaying to the segment.

18. The computer-based method of claim 16, wherein the demand side platform is an advertisement retargeting system.

19. The computer-based method of claim 1, wherein causing the advertising unit to be displayed comprises:
bidding on an advertising impression to display the advertising unit only to the person, or
direct dealing with an advertisement publisher to display the advertising unit only to the person.

20. The computer-based method of claim 1, further comprising:
causing the advertising unit to no longer be displayed to the person in response to an indication that one or more criterion have been satisfied.

21. The computer-based method of claim 1, wherein the web-based information resource is a web page, a web site, a mobile application, or any other software application capable of supporting functionality associated with the web-based information resource described herein.

22. The computer-based method of claim 1, wherein tracking the person's activities on the web-based information resource comprises tracking the person's accessing of or presence on the web-based information resource, as well as any clicks, behaviors and actions at the web-based information resource.

23. The computer-based method of claim 1, further comprising:
causing a second advertising unit to be displayed to the person or a segment associated with the person, in response to an indication that one or more criteria has been satisfied.

24. A computer-based method to facilitate communicating with a visitor to a web-based information resource, the method comprising:
tracking a person's activities on a web-based information resource, wherein the tracking comprises:
assigning a fingerprint to the person or an application that the person used to access the web-based information resource and/or sending a cookie to the application that the person used to access the web-based information resource;
creating a record that includes information about one or more of the person's activities on the web-based information resource or demographics; and
associating the record with the fingerprint, the cookie or the fingerprint and the cookie;
presenting to an agent associated with the web-based information resource information related to the tracking of the person's activities on the web-based information resource or demographics;
receiving input from the agent in response to presenting the information, wherein the input from the agent comprises the agent's instructions to communicate with person;
converting at least part of the agent's instructions to an advertising unit with a format that can be displayed as an advertisement on one or more of the web-based information resources that support advertising; and
causing the advertising unit to be displayed at one or more of the web-based information resources that support advertising.

25. The computer-based method of claim 24, wherein causing the advertising unit to be displayed at one or more of the web-based information resources that support advertising happens only in response to an indication that the person is visiting that one of the web-based information resources that supports advertising.

26. The computer-based method of claim 24, wherein the agent is a human who enters the instructions at a computer, and wherein
the instructions are entered by the human after the person's activities have been tracked and in response to a prompt to the human at the computer, or
the instructions are entered by the human in advance of tracking the person's activities on the web-based information resource.

27. The computer-based method of claim 24, wherein the agent is a computer server configured to provide the instructions.

28. The computer-based method of claim 24, wherein the advertising unit is not displayed absent an indication that the person is visiting one of the web-based information resources that supports advertising.

29. The computer-based method of claim 24, wherein the advertising unit that appears at one or more of the web-based information resources that support advertising includes a message specifically targeted to the person and no one else.

30. The computer-based method of claim 24, wherein causing the advertising unit to be displayed comprises:
requesting that a demand side platform create a segment having a particular designation; and
executing code from the demand side platform into an application that the person used to access the web-based information resource, wherein the code is configured such that, when run at the person's application, the demand side platform adds the person or the person's application to the segment,
or
bidding on an advertising impression to display the advertising unit only to the person,
or
direct dealing with an advertisement publisher to display the advertising unit only to the person.

31. The computer-based method of claim 24, further comprising:
causing the advertising unit to no longer be displayed to the person in response to an indication that one or more criterion have been satisfied.

32. A computer-based processing system to facilitate communicating with a visitor to a web-based information resource, the computer-based processing system comprising:
one or more computer-based processors; and
one or more computer-based memory devices coupled to the one or more computer-based processors, wherein the one or more computer-based processors are configured to:
track a person's activities on the web-based information resource;
receive instructions from an agent associated with the web-based information resource to communicate with the person whose activities have been tracked; and
create an advertising unit with a communication to the person based on the agent's instructions,
wherein the advertising unit is caused to be displayed at one or more web-based information resources that support advertising.

33. The computer-based processing system of claim 32, wherein the advertising unit is caused to be displayed at one or more of the web-based information resources that support advertising only in response to an indication that the person is visiting that one of the web-based information resources that support advertising.

34. The computer-based processing system of claim 32, wherein the agent is a human who enters the instructions at a computer or a computer server configured to provide the instructions, and wherein, if the agent is human:
the instructions are entered by the human after the person's activities have been tracked and in response to a prompt to the human at the computer, or
the instructions are entered by the human in advance of tracking the person's activities on the web-based information resource.

35. The computer-based processing system of claim 32, wherein the advertising unit is not displayed absent an indication that the person is visiting one of the web-based information resources that supports advertising.

36. The computer-based processing system of claim 32, wherein the one or more computer-based processors are configured to track the person's activities on the web-based information resource by:
assigning a fingerprint to the person or an application that the person used to access the web-based information resource and/or sending a cookie to the application that the person used to access the web-based information resource;
creating a record that includes information about one or more of the person's activities on the web-based information resource or demographics; and
associating the record with the fingerprint, the cookie or the fingerprint and the cookie.

37. The computer-based processing system of claim 32, wherein the one or more computer-based processors are configured to receive instructions from the agent by:
presenting to the agent information related to the tracking of the person's activities on the web-based information resource or demographics; and
receiving input from the agent in response to presenting the information, wherein the input from the agent comprises the agent's instructions to communicate with the person.

38. The computer-based processing system of claim 37, wherein presenting the information to the agent occurs only if the tracked activities of the person at the web-based information resource satisfy one or more criteria.

39. The computer-based processing system of claim 32, wherein the agent's instructions include a message specifically targeted to the person and no one else, and
wherein the advertising unit that appears at one of the web-based information resources that support advertising includes the message specifically targeted to the person and no one else.

40. The computer-based processing system of claim 32, wherein the agent's instructions identify a web address for a landing page that will appear if the person clicks on the advertising unit when it is displayed at one or more of the web-based information resources that support advertising.

41. The computer-based processing system of claim 32, wherein the one or more computer-based processors are configured to create the advertising unit with the communication to the person based on the agent's instructions by:
converting at least part of the agent's instructions to a format that can be displayed as an advertisement on the one or more web-based information resources that support advertising.

42. The computer-based processing system of claim 32, wherein causing the advertising unit to be displayed at one or more of the web-based internet resources comprises:
requesting that a demand side platform create a segment having a particular designation; and
executing code from the demand side platform into an application that the person used to access the web-based information resource, wherein the code is configured such that, when run at the person's application, the demand side platform adds the person or the person's application to the segment,
or
bidding on an advertising impression to display the advertising unit only to the person,
or
direct dealing with an advertisement publisher to display the advertising unit only to the person.

43. A computer-based system to facilitate communicating with a visitor to a web-based information resource, the computer-based system comprising:
a computer with an application that facilitates accessing one or more web-based information resources;
a plurality of computer servers coupled to the computer via a computer-based network, each computer server hosting one or more of the web-based information resources, wherein at least one of the web-based information resources supports advertising; and
a computer-based processing system comprising:
one or more computer-based processors; and
one or more computer-based memory devices coupled to the one or more computer-based processors, wherein the one or more computer-based processors are configured to:
track a person's activities while on one of the web-based information resources via one of the applications that facilitate accessing web-based information resources;
receive instructions from an agent associated with the accessed web-based information resource to communicate with the person whose activities have been tracked; and
create an advertising unit with a communication to the person whose activities have been tracked based on the agent's instructions,
wherein the advertising unit is caused to be displayed at one or more of the web-based information resources that support advertising.

44. The computer-based system of claim 43, wherein the advertising unit is caused to be displayed at one or more of the web-based information resources that support advertising only in response to an indication that the person is visiting that one of the web-based information resources that supports advertising.

45. The computer-based system of claim 43, wherein the agent is a human who enters the instructions at a computer or a computer server configured to provide the instructions, and wherein, if the agent is human:
the instructions are entered by the human after the person's activities have been tracked and in response to a prompt to the human at the computer, or
the instructions are entered by the human in advance of tracking the person's activities on the web-based information resource.

46. The computer-based system of claim 43, wherein causing the advertising unit to be displayed comprises:
requesting that a demand side platform create a segment having a particular designation; and
executing code from the demand side platform into an application that the person used to access the web-based information resource, wherein the code is configured such that, when run at the person's application, the demand side platform adds the person or the person's application to the segment,
or
bidding on an advertising impression to display the advertising unit only to the person,
or
direct dealing with an advertisement publisher to display the advertising unit only to the person.

47. The computer-based system of claim 43, wherein the advertising unit is not displayed absent an indication that the person is visiting one of the web-based information resources that support advertising.

48. A non-transitory, computer-readable medium storing instructions executable by a computer-based processor to perform the steps comprising:
tracking a person's activities on the web-based information resource;
receiving instructions from an agent associated with the web-based information resource to communicate with the person whose activities have been tracked;
creating an advertising unit with a communication to the person based on the agent's instructions; and
causing the advertising unit to be displayed at one or more web-based information resources that support advertising.

49. The non-transitory, computer-readable medium of claim 48, further comprising instructions to ensure that causing the advertising unit to be displayed at one or more web-based information resources that support advertising happens only in response to an indication that the person is visiting one of the web-based information resources that support advertising.

50. The non-transitory, computer-readable medium of claim 48, wherein the advertising unit is not displayed absent an indication that the person is visiting one of the web-based information resources that support advertising.
